SEQUENCE LISTING (11 sequences)

SEQ ID NO: 1 - protein, 101 aa, Homo sapiens
MSNTQAERSIIGMIDMFHKYTRRDDKIEKPSLLTMMKENFPNFLSACDKKGTNYLADVFEKKDKNEDKKIDFSEFLSLLGDIATDYHKQSHGAAPCSGGSQ

SEQ ID NO: 2 - protein, 101 aa, Homo sapiens
MARPLEQAVAAIVCTFQEYAGRCGDKYKLCQAELKELLQKELATWTPTEFRECDYNKFMSVLDTNKDCEVDFVEYVRSLACLCLYCHEYFKDCPSEPPCSQ

SEQ ID NO: 3 - protein, 93 aa, Homo sapiens
MLTELEKALNSIIDVYHKYSLIKGNFHAVYRDDLKKLLETECPQYIRKKGADVWFKELDINTDGAVNFQEFLILVIKMGVAAHKKSHEESHKE

SEQ ID NO: 4 - protein, 114 aa, Homo sapiens
MTCKMSQLERNIETIINTFHQYSVKLGHPDTLNQGEFKELVRKDLQNFLKKENKNEKVIEHIMEDLDTNADKQLSFEEFIMLMARLTWASHEKMHEGDEGPGHHHKPGLGEGTP

SEQ ID NO: 5 - protein, 92 aa, Homo sapiens
MSELEKAMVALIDVFHQYSGREGDKHKLKKSELKELINNELSHFLEEIKEQEVVDKVMETLDNDGDGECDFQEFMAFVAMVTTACHEFFEHE

SEQ ID NO: 6 - protein, 92 aa, Homo sapiens
MTKLEEHLEGIVNIFHQYSVRKGHFDTLSKGELKQLLTKELANTIKNIKDKAVIDEIFQGLDANQDEQVDFQEFISLVAIALKAAHYHTHKE

SEQ ID NO: 7 - protein, 119 aa, Chlorocebus sabaeus
MEGKKWLSLFPEAFVKAKMSNTQAETSIIGMIDMFHKYTRRDDKIDKPSLLTMMKENFPNFLSACDKKGIHYLASVFERKDKNEDKKIDFSEFLSLLGDIATDYHKESHGGAPCSGGSQ

SEQ ID NO: 8 - protein, 101 aa, Molossus molossus
MSHTEVEKSVMGMIDLFHRYTKPDDTIDKPGLLKMLKENFPTFLAACDKKGKDYLSNIFEKKDKNMDKKIEFSEFLSLLGDIATDYHNQSHGAPPCSGGSQ

SEQ ID NO: 9 - protein, 101 aa, Homo sapiens
MSNTQAERSIIGMIDMFHKYTGRDGKIEKPSLLTMMKENFPNFLSACDKKGIHYLATVFEKKDKNEDKKIDFSEFLSLLGDIAADYHKQSHGAAPCSGGSQ

SEQ ID NO: 10 - DNA, 366 bp, synthetic construct
  source 1..366: mol_type = other DNA
atgggcagcagccatcatcatcatcatcacagcagcggcctggtgccgcgcggcagccatatgagcaacacccaggcggagcgtagcatcattggtatgatcgatatgttccacaagtacacccgtcgtgacgataagattgagaaaccgagcctgctgaccatgatgaaagaaaacttcccgaactttctgagcgcgtgcgataagaaaggcaccaactacctggcggacgtgtttgagaagaaagacaagaacgaagataagaaaatcgacttcagcgaatttctgagcctgctgggtgatattgcgaccgactatcacaaacagagccacggcgcggcgccgtgcagcggtggcagccaataa

SEQ ID NO: 11 - protein, 121 aa, synthetic construct
MGSSHHHHHHSSGLVPRGSHMSNTQAERSIIGMIDMFHKYTRRDDKIEKPSLLTMMKENFPNFLSACDKKGTNYLADVFEKKDKNEDKKIDFSEFLSLLGDIATDYHKQSHGAAPCSGGSQ

(19) United States
(12) Patent Application Publication
(10) Pub. No.: US 2026/0231968 A1
(43) Pub. Date: Aug. 13, 2026

(54) AN ECO-FRIENDLY, SUSTAINABLE FOOD PRESERVATIVE

(71) Applicants: BOUNTICA LTD., Tel Mond (IL); RAMOT AT TEL-AVIV UNIVERSITY LTD., Tel Aviv (IL)

(72) Inventors: Maayan GAL, Tel Aviv (IL); Yoav BREUER, Tel Aviv (IL); Fabian TRUMPER, Modi'in (IL)

(73) Assignees: BOUNTICA LTD., Tel Mond (IL); RAMOT AT TEL-AVIV UNIVERSITY LTD., Tel Aviv (IL)

(21) Appl. No.: 19/161,206

(22) PCT Filed: Feb. 29, 2024
(86) PCT No.: PCT/IL2024/050230

§ 371 Date: Aug. 29, 2025

Related U.S. Application Data
(60) Provisional application No. 63/487,634, filed on Mar. 1, 2023.

(51) Int. Cl. A23B 2/762

(52) U.S. Cl. CPC A23B 2/762

(57) ABSTRACT

The present invention is directed to methods and compositions comprising S 100 proteins, for example psoriasin, useful as anti-fungal and anti-bacterial food and beverage preservatives. Sequence-specified S 100 proteins are provided which inhibit the microbial proliferation and/or microbial-induced spoilage

### FIELD OF THE INVENTION

The present invention relates to compositions comprising S100 proteins, for example, psoriasin and homologs thereof, for use in preventing microbial growth in food and beverages.

### BACKGROUND OF THE INVENTION

The Food and Agriculture Organization estimates that about 30% of the total volume of food is lost due to food waste from postharvest to retail and consumers. Such high losses have an immense worldwide impact on global food security, as well as on economic losses and negative environmental consequences due to increased greenhouse gas emissions. Postharvest food losses are mainly attributed to spoilage due to the activity of microorganisms (mold, yeast, and/or bacteria) and oxidation. The World Health Organization predicts that 420,000 people die each year from ingesting contaminated food.

The majority of food preservatives in current use are chemical preservatives. These are relatively low-cost and easy to handle. Chemical preservatives include potassium sorbate, sodium benzoate, sodium nitrate, sodium nitrite, and benzoic acid. However, a variety of health hazards are known to be associated with the use of such compounds. For instance, it was shown that benzoic acid, one of the most commonly used chemical preservative, could lead to protein fibrillation, which has been linked to many neurodegenerative diseases. Besides health-related issues, the effective activity of chemical preservatives is often limited to a narrow range of conditions. For instance, potassium sorbate is active only at a relatively low pH, thereby posing a challenge in preserving fresh food at its natural pH.

As consumer awareness of the negative effects of chemical preservatives grows, the food industry is turning to ‘clean-label’ food products, which have minimal to no synthetic preservatives and processing. Proteins and peptides, such as gelatin, zein, and whey can offer a natural alternative for preserving food and preventing spoilage and contamination. Moreover, proteins and peptides are naturally digestible, breaking down into amino acids within the human gastric system, thereby posing no health risks due to toxicity. In recent years, ongoing studies are exploring the use of certain classes of proteins and peptides in a variety of food-related applications.

Psoriasin, also known as S100a7 or S100a7c, is a protein naturally produced by mammals with established antimicrobial therapeutic characteristics. Psoriasin belongs to the S100 protein family that exists as dimers and multimers in cells forming the Ca²⁺ binding EF-domains. S100 proteins are involved in various physiological processes, including cell differentiation, inflammation, and the immune system.

Hein et al. (PNAS 2015; 112(42): 13039-13044) disclose that a cysteine-reduced form of the ubiquitous epithelial protein psoriasin (S100a7) acts as a principal human antifungal protein. This protein induces apoptosis in fungi by penetrating the fungal cell membrane and sequestrating Zn²⁺ from an intracellular target via a newly formed thiol-based metal-binding site. It is suggested that fungus-cell-penetrating Zn²⁺-chelators, like redS100a7 and TPEN, could be therapeutically useful in fungal infections.

Brauner et al. (J Mol Med (Berl). 2018; 96(6): 537-545) conducted a study to investigate a panel of antimicrobial proteins and peptides (AMPs) that may be involved in the mucosal immunity against the pathogen Candida albicans. Of the six AMPs studied, psoriasin was the most up-regulated during an acute episode of recurrent Candida vulvovaginitis. Although it has not been shown to have candidacidal activity, psoriasin was found to bind to β-glucan, a basic component of the C. albicans cell wall, which inhibits the pathogen's adhesion to surfaces and increases IL-8 production by mucosal epithelial cells. It was concluded that by inhibiting C. albicans adhesion and enhancing cytokine production, psoriasin contributes to the immune response against this pathogen.

JP 2015116137 describes the use of S100a7 proteins as an antifungal therapy against filamentous fungi.

EP 2563916 describes methods for eliminating, reducing or preventing bacterial biofilms using fusion proteins comprising an endolysin or a bacteriocin fused to a peptide with membrane or LPS disrupting activity. The methods are not intended for use in the treatment of the human or animal body by surgery or therapy. The fusion proteins are further indicated in EP 2563916 for use as a medicament, particularly for the treatment or prevention of Gram-negative and/or Gram-positive bacterial infections associated with bacterial biofilms, as a diagnostic tool, as a disinfectant or as a cosmetic substance. EP 2563916 also describes the use of these fusion proteins for the prevention, reduction or removal of Gram-negative and/or Gram-positive bacterial contamination associated with bacterial biofilm on foodstuffs, food processing equipment, food processing plants, surfaces that come into contact with foodstuffs, medical devices, surfaces in hospitals and surgeries.

There remains an unmet need for eco-friendly, sustainable, and safe material having antifungal and antibacterial properties that provides an effective alternative to chemical food preservatives.

### SUMMARY OF THE INVENTION

The present invention provides preservative compositions comprising at least one S100 protein, preferably psoriasin or a homolog thereof, for preventing or reducing spoilage in food and beverages induced by microorganisms.

The invention is based, in part, on the unexpected finding that proteins belonging to the S100 family can be used as inhibitors of growth of fungi and bacteria in food and beverages products while maintaining the organoleptic properties of the products. Specifically, in recent years, global awareness has substantially grown with respect to the use of chemical preservatives that have notoriously been associated with several health risks to consumers. In addition to potential health risks, chemical preservatives may exert limited activity to certain types of microbes and conditions of use. The present invention provides an eco-friendly, sustainable, and broad-spectrum preservative that can be safely consumed as an edible food ingredient. Unexpectedly, S100 proteins, including S100a7, S100a8, S100a9, and S100a12, were shown to inhibit fungal and bacterial growth in food and beverages at a wide range of pH, temperatures, and concentrations without compromising the flavor, texture, aroma, and consistency of the food and beverage products. Surprisingly, these proteins were able to maintain their efficacy in inhibiting microbial growth over long periods of time spanning for days or even weeks, which is particularly advantageous in food and beverages preservation. The invention also provides a means to obviate the use of heat treatments, such as pasteurization, that adversely affect the taste and other organoleptic properties of edible products.

According to a first aspect, the present invention provides a method for inhibiting microbial proliferation and/or microbial-induced spoilage in a food or a beverage, the method comprises adding a composition comprising at least one S100 protein to the food or beverage.

According to another aspect, the present invention provides the use of a composition comprising at least one S100 protein as an anti-microbial agent in a food or a beverage.

According to yet another aspect, the present invention provides a method for preserving a food or a beverage, the method comprises adding a composition comprising at least one S100 protein to the food or beverage.

According to a further aspect, the present invention provides a food or a beverage comprising an effective amount of a composition comprising at least one S100 protein as a preservative.

In one embodiment, the at least one S100 protein is selected from the group consisting of S100a3, S100a7, S100a8, S100a9, S100a12, S100a15, S100b, and homologs thereof. Each possibility represents a separate embodiment. In another embodiment, the at least one S100 protein is S100a7 or a homolog thereof. In yet another embodiment, the at least one S100 protein is S100a7 having an amino acid sequence as set forth in SEQ ID NO: 1. In another embodiment, the at least one S100 protein comprises an amino acid sequence having at least 80% homology to the sequence as set forth in SEQ ID NO: 1.

In various embodiments, the concentration of the at least one S100 protein in the food or beverage which is effective in inhibiting microbial-induced spoilage is at least 50 nM. In other embodiments, the concentration of the at least one S100 protein in the food or beverage is in the range of about 100 nM to about 500 μM, including each value within the specified range.

In certain embodiments, the microbial proliferation and/or microbial-induced spoilage is induced by fungi. In some embodiments, the fungi comprise yeast or mold. Each possibility represents a separate embodiment. According to certain embodiments, the yeast comprises at least one of Zygosaccharomyces rouxii, Saccharomyces cerevisiae, Pichia membranaefaciens, Candida crusei, Dekkera bruxellensis, Pichia anomala, Zygosaccharomyces baiii, Dekkera naardensis, and Candida albicans. Each possibility represents a separate embodiment. According to other embodiments, the mold comprises at least one of Aspergillus flavus, Byssochlamys nivea, Byssochlamys fulva, Neosartorya fischeri, Talaromyces harzanium, Fusarium solani, Aspergillus fumigatis, Aspergillus niger, Penicillium crustosum, Penicillium digitatum, Penicillium roqueforti, Fusarium oxysporum, and Mucor rouxii. Each possibility represents a separate embodiment.

In further embodiments, the microbial proliferation and/or microbial-induced spoilage is induced by bacteria. In various embodiments, the bacteria comprise at least one of Brochothrix thermosphacta, Carnobacterium spp., Lactobacillus spp., Lactococcus spp., Leuconostoc spp., Pediococcus spp., Stretococcus spp., Kurthia zopfii, Clostridium perfringens, Escherichia coli, Salmonella spp., Listeria monocytogenes, Enterobacter spp., and Weissella spp. Each possibility represents a separate embodiment.

In some embodiments, the food comprises a water content of at least 5%. In other embodiments, the food comprises a water content of at least 10%. In yet other embodiments, the food comprises a water content of at least 20%.

In additional embodiments, the food or beverage has a pH in the range of about 1 to about 12, including each value within the specified range. In particular embodiments, the food or beverage has a pH in the range of about 5 to about 10, including each value within the specified range.

In certain embodiments, the food or beverage has a divalent ion. In one embodiment, the food or beverage has a divalent ion concentration of less than 50 mM. In other embodiments, the food or beverage has a divalent ion concentration of less than 10 mM. In yet other embodiments, the food or beverage has a divalent ion concentration of less than 1 mM. In further embodiments, the food or beverage has a divalent ion concentration of less than 0.5 mM. In additional embodiments, the food or beverage has a divalent ion concentration of less than 0.1 mM. In various embodiments, the food or beverage has a divalent ion concentration of less than 0.05 mM. In specific embodiments, the food or beverage has a divalent ion concentration of less than 10 μM. In yet other specific embodiments, the food or beverage has a divalent ion concentration of less than 5 μM. In further embodiments, the food or beverage has a divalent ion concentration of less than 1.2 μM.

In other embodiments, the molar ratio between the divalent ion concentration and the at least one S100 protein in the food or beverage is about 1:1 or less.

In further embodiments, the molar ratio between the divalent ion concentration and the at least one S100 protein in the food or beverage is in the range of 1:1 to 1:1000, including each value within the specified range. In particular embodiments, the divalent ion is selected from the group consisting of zinc ions, calcium ions, magnesium ions, and combinations thereof. Each possibility represents a separate embodiment. In one embodiment, the divalent ions are zinc ions.

In various embodiments, the food is semi-solid or solid. Each possibility represents a separate embodiment.

In certain embodiments, the food is selected from the group consisting of meat or poultry products, substitute meat or poultry products, fish products, fish substitute products, dairy products, substitute dairy products, bakery products, fruit and vegetable dishes, confectionaries, snack foods, soups, sauces, spreads, and dressings. Each possibility represents a separate embodiment.

In other embodiments, the beverage is selected from the group consisting of soft drinks, juices and nectars, milk and milk-based drinks, substitute milk and milk-based drinks, hot drinks, and alcoholic drinks. Each possibility represents a separate embodiment.

In various embodiments, the food or beverage is essentially devoid of additional food or beverage preservatives.

In additional embodiments, the composition comprising at least one S100 protein is useful as a preservative of cell culture media.

In certain embodiments, the composition is in the form of a solution, a paste, a gel or a powder. Each possibility represents a separate embodiment.

In further embodiments, the composition further comprises at least one additive. In specific embodiments, the at least one additive is selected from the group consisting of antioxidants, flavoring agents, nutrients, sweeteners, thickeners, colorants, emulsifiers, antifoaming agents, and a mixture or combination thereof. Each possibility represents a separate embodiment.

In one embodiment, the composition comprises a single S100 protein or a homolog thereof. In another embodiment, the composition comprises a combination of two or more S100 proteins or homologs thereof.

In some embodiments, the composition comprising at least one S100 protein is provided in combination with at least one additional food or beverage preservative. In other embodiments, the at least one additional food or beverage preservative is selected from the group consisting of nisin, potassium sorbate, sodium benzoate, sodium nitrate, sodium nitrite, benzoic acid, and a mixture or combination thereof. Each possibility represents a separate embodiment. In one embodiment, the at least one additional food or beverage preservative is nisin.

In further embodiments, the composition comprising at least one S100 protein extends the shelf life of the food or beverage by at least 1.5 to 10-fold compared to the shelf life of the food or beverage without any added preservatives.

It is to be understood that any combination of each of the aspects and the embodiments disclosed herein is explicitly encompassed within the disclosure of the present invention.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIG. 1. Growth curves of Aspergillus flavus at different His-psoriasin concentrations.

FIG. 2. Growth curves of Candida albicans at different His-psoriasin concentrations.

FIG. 3. Growth curves of Candida albicans in the presence of His-psoriasin at different zinc ions concentrations.

FIGS. 4A-4B. (4A) Growth curves of Candida albicans in the presence of His-psoriasin at different pHs. (4B) Growth curves of Candida albicans in the absence of His-psoriasin at different pHs.

FIG. 5. Growth curves of Candida albicans in apple juice in the presence of His-psoriasin.

FIGS. 6A-6D. Evaluation of His-psoriasin activity in chickpea paste of samples that were either not inoculated (6A and 6C) or inoculated (6B and 6D) with Aspergillus flavus at t=0 (6A and 6B) and t=240 hours (6C and 6D). Top samples correspond to treatment with 180 μM psoriasin and bottom samples correspond to untreated samples.

FIG. 7. Chickpeas paste fungi load detected on agar plates in the presence of different His-psoriasin concentrations.

FIGS. 8A-8B. Evaluation of the activity of His-psoriasin in combination with nisin. (8A) Evaluation of the total microbial count on LB-agarose plates containing no antibiotics. (8B) Evaluation of the total yeast/mold count on YAG plates with antibiotics.

FIGS. 9A-9B. Evaluation of psoriasin activity on microbes isolated from soy protein. Microbial growth in (9A) LB, and (9B) RPMI.

FIGS. 10A-10C. (10A) Growth curves of E. coli in the presence of different concentrations of S100a8. (10B) Growth curves of E. coli in the presence of different concentrations of S100a9. (10C) Growth curves of E. coli in the presence of different equimolar concentrations of S100a8 and S100a9.

FIG. 11. Growth curves of Candida albicans in the presence of different concentrations of S100a12.

FIGS. 12A-12D. Comparison of antimicrobial activity of psoriasin that was admixed with dough before baking vs. calcium propionate and untreated rolls. (12A) Images of slices of bread in the absence of psoriasin and (12B) in the presence of psoriasin. (12C) Images of the rolls and (12D) microbial growth on LB media after 10 days at room temperature.

FIG. 13. Comparison of microbial load of plant based-meat substitute stored at 6° C. without preservative (untreated), with nisin, and with psoriasin.

FIGS. 14A-14B. (14A) Comparison of microbial load of hummus salad prepared at pH 4.8 and stored at 6° C. without preservative (untreated), with potassium sorbate, and with psoriasin on days 0, 12, 26, and 62. (14B) Comparison of microbial load of hummus salad prepared at the natural pH of 6.5 and stored at 6° C. without preservative (untreated), with nisin, and with psoriasin on days 1, 22, 32, and 39.

FIG. 15. Activity of psoriasin at different temperatures.

FIG. 16. Antimicrobial activity of psoriasin (peptide) at different concentrations compared with ethyl lauroyl arginate (LAE) against A. flavus.

FIG. 17. Evaluation of cell viability in the presence of different concentrations of psoriasin.

FIGS. 18A-18B. The activity of psoriasin following lyophilization (18A) and oven drying (18B).

### DETAILED DESCRIPTION OF THE INVENTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

The present invention provides an edible composition comprising a protein, for example the mammalian protein psoriasin or a homolog thereof, for use in inhibiting microbial-induced spoilage in food or beverages. The present invention further provides methods of food and beverages preservation, the methods comprise contacting or admixing the food or beverages with a composition comprising the protein.

The present invention discloses for the first time the use of proteins and peptides containing a zinc-binding motif, such as psoriasin and analogs thereof, as food and beverages preservatives. The hitherto known traditional preservatives have potential health concerns if consumed in large quantities. In addition, they may also have a negative impact on the taste and quality of the food and beverages products. Furthermore, various strains of bacteria have been observed to develop resistance to certain preservatives, resulting in their reduced effectiveness over time. While the process of pasteurization or other heat treatment is effective in extending the shelf life of milk and juices, it is known to adversely affect the organoleptic properties of those liquids. Additionally, heat treatment processes require expensive infrastructure. Thus, there is a growing demand for natural and environmentally friendly alternatives that can be safely consumed by oral ingestion without compromising the organoleptic characteristics of the products.

It was surprisingly found that S100 proteins can be used as anti-fungal and/or anti-bacterial agents in food and beverage products. Their safety profile and natural origin render them desirable for use as preservatives in food and beverage products. Additionally, these proteins do not alter the taste, odor, or appearance of food and beverage products, thereby being highly suitable for use as preservatives.

Unexpectedly, these proteins were shown to demonstrate long-term efficacy in inhibiting microbial proliferation, said long term efficacy is particularly advantageous for use in food and beverage products. Advantageously, the S100 proteins were shown to be stable in solution for up to one hour at temperatures of up to 85° C. without significant loss of activity. The use of these proteins in food and beverage products leads to reduced food waste by extending the shelf life of the products and by preserving the quality and inhibiting the degradation of their ingredients. Furthermore, more sustainable and safer products for consumption are obtained by reducing the need for chemical preservatives or other antimicrobial agents that may have negative environmental and health impacts.

According to some aspects and embodiments, the present invention provides a method for inhibiting microbial proliferation or spoilage in food or beverages induced by microbes, the method comprising adding a composition comprising a protein or a peptide comprising a zinc-binding motif to the food or beverages. As used herein, the terms “inhibiting” or “inhibit” refer to a reduction of at least about 5%, 10%, 15%, 20%, 25%, 30%, 35%, 40%, 45%, 50%, 55%, 60%, 65%, 70%, 75%, 80%, 85%, or 90% in microbial growth in a food or beverage as compared with the same food or beverage not treated with the composition comprising the protein or peptide disclosed herein or any other substance known as a food or beverage preservative. Each possibility represents a separate embodiment. The terms “microbial” or “microbe” as used herein relate to a microorganism including, but not limited to, bacteria, fungi, and mold. Each possibility represents a separate embodiment.

Thus, according to the principles of the present invention, there is provided the use of a protein or a peptide comprising a zinc-binding motif as a food or beverage preservative. The term “preservative” as used herein refers to any substance that, when added to a food or a beverage, lessens spoilage as well as extends shelf life or expiration date of the food or beverage as compared with the same food or beverage not treated with the composition comprising the protein or peptide or any other substance known as a food or beverage preservative.

According to some aspects and embodiments, the protein comprising a zinc-binding motif is a mammalian protein comprising a zinc-binding motif.

According to other aspects and embodiments, the zinc-binding motif comprises at least one of Formula I and Formula II:

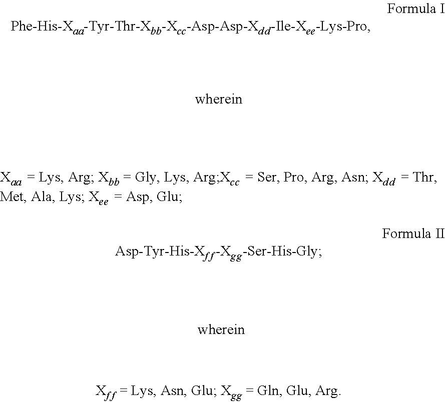

According to yet other aspects and embodiments, the zinc-binding motif comprises at least one of Formula III and Formula IV:

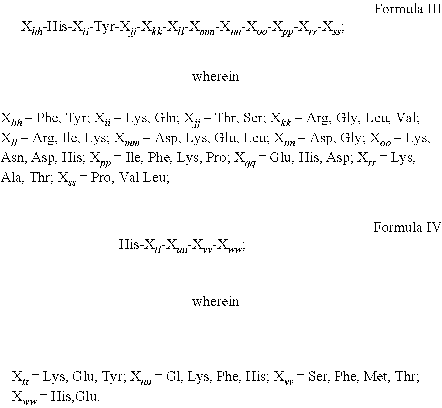

According to various aspects and embodiments, compositions and methods in accordance with the invention employ the use of proteins having a zinc-binding motif which comprises an His₃Asp, His₃Glu or His₄ binding motif. Each possibility represents a separate embodiment. In yet other embodiments, the zinc-binding motif does not comprise a zinc-finger motif.

According to certain aspects and embodiments, the protein or peptide comprising a zinc-binding motif is an S100 protein. The S100 protein family includes a range of evolutionary conserved non-ubiquitous polypeptides expressed in vertebrates exclusively, that are characterized by common structural and functional properties. In humans, S100 gene family members are located within the S100 gene cluster on chromosome 1q21.

Structurally, S100 proteins are a low molecular-weight proteins characterized by two calcium-binding sites that have helix-loop-helix (“EF-hand-type”) conformation. Functionally, upon calcium binding, the S100 proteins undergo a large conformational change that creates a special target protein recognition site and allows interaction with different target proteins, including cell surface receptors and other S100 proteins. Currently known members of the S100 family within the scope of the present invention include, but are not limited to, proteins S100a1, S100a2, S100a3, S100a4, S100a5, S100a6, S100a7 (Psoriasin), S100a8, S100a9, S100a10, S100a11, S100a12, S100a13, S100a14, S100a15 (Koebnerisin), S100a16, S100b, S100p, S100z, CRNN, FLG, HRNR, IFPS, RPTN, S100g, TCHH, and THHL1. Each possibility represents a separate embodiment. Exemplary S100 proteins suitable according to certain embodiments of the present invention are selected from the group consisting of S100a3, S100a7, S100a8, S100a9, S100a12, S100a15, S100b, and combinations thereof. Each possibility represents a separate embodiment.

According to some aspects and embodiments, the protein is psoriasin or S100a7. The terms “psoriasin”, “S100a7”, “S100a7c” and “S100 calcium binding protein a7”, as used herein, are interchangeable and refer to the psoriasin protein, which is a member of the S100 protein family, and/or protein analog, or variant thereof. “Psoriasin”, as used herein, refers to the human derived protein or any other mammalian-derived protein including, but not limited to, psoriasin originated from gorilla, chimpanzee, bonobo, gibbon, drill, monkey, mangabey, baboon, macaque, lutung, capuchin, orangutan, lemur, tupaia, donkey, dog, aardvark, rhinoceros, hyena, bat, mole, bovine, and the like. Each possibility represents a separate embodiment.

In one embodiment, the psoriasin protein used in implementing the teachings of the present invention is human psoriasin having a sequence as set forth in SEQ ID NO: 1:

MSNTQAERSIIGMIDMFHKYTRRDDKIEKPSLLTMMKENFPNFLSACDK
KGTNYLADVFEKKDKNEDKKIDFSEFLSLLGDIATDYHKQSHGAAPCSG
GSQ.

In another embodiment, the protein is human S100a3 having a sequence as set forth in SEQ ID NO: 2:

MARPLEQAVAAIVCTFQEYAGRCGDKYKLCQAELKELLQKELATWTPTE
FRECDYNKFMSVLDTNKDCEVDFVEYVRSLACLCLYCHEYFKDCPSEPP
CSQ.

In yet another embodiment, the protein is human S100a8 having a sequence as set forth in SEQ ID NO: 3:

MLTELEKALNSIIDVYHKYSLIKGNFHAVYRDDLKKLLETECPQYIRKK
GADVWFKELDINTDGAVNFQEFLILVIKMGVAAHKKSHEESHKE.

In other embodiments, the protein is human S100a9 having a sequence as set forth in SEQ ID NO: 4:

MTCKMSQLERNIETIINTFHQYSVKLGHPDTLNQGEFKELVRKDLQNFL
KKENKNEKVIEHIMEDLDTNADKQLSFEEFIMLMARLTWASHEKMHEGD
EGPGHHHKPGLGEGTP.

In additional embodiments, the protein is human S100b having a sequence as set forth in SEQ ID NO: 5:

MSELEKAMVALIDVFHQYSGREGDKHKLKKSELKELINNELSHFLEEIK
EQEVVDKVMETLDNDGDGECDFQEFMAFVAMVTTACHEFFEHE.

In further embodiments, the protein is human S100a12 having a sequence as set forth in SEQ ID NO: 6:

MTKLEEHLEGIVNIFHQYSVRKGHFDTLSKGELKQLLTKELANTIKNIK
DKAVIDEIFQGLDANQDEQVDFQEFISLVAIALKAAHYHTHKE.

In other embodiments, the protein is S100a7 derived from Chlorocebus sabaeus (Green monkey) having a sequence as set forth in SEQ ID NO: 7:

MEGKKWLSLFPEAFVKAKMSNTQAETSIIGMIDMFHKYTRRDDKIDKPS
LLTMMKENFPNFLSACDKKGIHYLASVFERKDKNEDKKIDFSEFLSLLG
DIATDYHKESHGGAPCSGGSQ.

In yet other embodiments, the protein is S100a7 derived from Molossus (Bat) having a sequence as set forth in SEQ ID NO: 8:

MSHTEVEKSVMGMIDLFHRYTKPDDTIDKPGLLKMLKENFPTFLAACDK
KGKDYLSNIFEKKDKNMDKKIEFSEFLSLLGDIATDYHNQSHGAPPCSG
GSQ.

In some embodiments, the protein is human S100a15 having a sequence as set forth in SEQ ID NO: 9:

MSNTQAERSIIGMIDMFHKYTGRDGKIEKPSLLTMMKENFPNFLSACDK
KGIHYLATVFEKKDKNEDKKIDFSEFLSLLGDIAADYHKQSHGAAPCSG
GSQ.

According to particular aspects and embodiments, the present invention provides a method for inhibiting fungal proliferation and/or fungi-induced spoilage in food or beverages, the method comprises adding a composition comprising psoriasin (S100a7) or a homolog thereof to the food or beverages. According to other particular aspects and embodiments, the present invention provides a method for inhibiting bacterial proliferation and/or bacterial-induced spoilage in food or beverages, the method comprises adding a composition comprising psoriasin (S100a7) or a homolog thereof to the food or beverages.

Within the scope of the present invention is a method for preserving food or beverages, the method comprises adding a composition comprising psoriasin (S100a7) or a homolog thereof to the food or beverages.

The present invention further provides the use of a composition comprising psoriasin (S100a7) or a homolog thereof as an anti-fungal agent in food or beverages. According to further aspects and embodiments, the present invention provides the use of a composition comprising psoriasin (S100a7) or a homolog thereof as an anti-bacterial agent in food or beverages.

Encompassed by the present invention is a food or a beverage comprising an effective amount of a composition comprising psoriasin (S100a7) or a homolog thereof as a preservative.

In some embodiments, the S100 protein used in implementing the teachings of the present invention is a polypeptide having a homology of at least 50% or more with the human psoriasin (S100a7) protein having a sequence as set forth in SEQ ID NO: 1. In other embodiments, the S100 protein used in implementing the teachings of the present invention is a polypeptide having a homology of at least 60% or more with the human psoriasin (S100a7) protein. In additional embodiments, the S100 protein used in implementing the teachings of the present invention is a polypeptide having a homology of at least 70% or more with the human psoriasin (S100a7) protein. In further embodiments, the S100 protein used in implementing the teachings of the present invention is a polypeptide having a homology of at least 80% or more with the human psoriasin (S100a7) protein. In particular embodiments, the S100 protein used in implementing the teachings of the present invention is a polypeptide having a homology of at least 90% or more with the human psoriasin (S100a7) protein. Encompassed within the scope of the present invention are different oxidation states of S100 proteins or homologs thereof.

The term “homolog” as used herein refers to a second protein which has a similar amino acid sequence to that of the first protein. As known to those skilled in the art, similarity between two protein sequences can be determined based on sequence alignment as the percent sequence identity between two proteins after aligning their sequences using a sequence alignment algorithm. Examples of such algorithms include, but are not limited to, BLAST, HMMER3, PSI-BLAST, and FASTA. Additionally or alternatively, the term “homolog” may refer to a second protein which shares a statistically significant similarity to the amino acid sequence of the first protein or a statistically significant structural similarity to the first protein. Most often, in addition to sequence or structural similarity, the homologs also demonstrate functional similarity.

While the S100 protein of the present invention may comprise a wild type amino acid sequence, it is to be understood that variants are also within the scope of the present invention. Thus, according to certain aspects and embodiments, the present invention provides isolated S100 variants and use thereof as food and beverages preservatives. The term “variant” as used herein refers to a polypeptide sequence that possesses some modified structural property of the wild type or parent protein. For example, the variant may be truncated at either the amino or carboxy terminus or both termini or may have one or more amino acids deleted, inserted and/or substituted. Each possibility represents a separate embodiment. The term “amino acids” used in the invention are those that are natural, those that are available commercially or are available by routine synthetic methods. Natural coded amino acids and their derivatives are represented by either the one-letter code or three-letter codes according to IUPAC conventions. Typically, variants will include conservative substitutions of amino acids as known to those skilled in the art. Conservative amino acid substitutions include replacement of one amino acid with another having the same type of functional group or side chain e.g., aliphatic, aromatic, positively charged, and negatively charged. These substitutions may enhance activity, stability and the like of the S100 native protein. One of skill in the art will recognize that individual substitutions, deletions or additions to the protein sequence which alter, add or delete a single amino acid or a small percentage of amino acids in the encoded sequence are “conservatively modified variants” where the alterations result in the substitution of an amino acid with a chemically similar amino acid. Conservative substitution tables providing functionally similar amino acids are well known in the art.

The following six groups each contain amino acids that are conservative substitutions for one another: (1) Alanine (A), Serine (S), Threonine (T); (2) Aspartic acid (D), Glutamic acid (E); (3) Asparagine (N), Glutamine (Q); (4) Arginine (R), Lysine (K); (5) Isoleucine (I), Leucine (L), Methionine (M), Valine (V); and (6) Phenylalanine (F), Tyrosine (Y), Tryptophan (W). According to some embodiments, the S100 protein or a homolog thereof may be fused at any one of its N- or C-termini to a protein or peptide, for example, a tag such as a His tag, a CPP tag, a solubility tag, and the like. Each possibility represents a separate embodiment.

The most preferred method for producing the variants is through recombinant DNA technologies, well known to those skilled in the art. For example, the variants may be prepared by Polymerase Chain Reaction (PCR) using specific primers for each of the truncated forms or the amino acid substitutions. The PCR fragments may be purified on an agarose gel and the purified DNA fragment may be cloned into an expression vector and transfected into host cells. The host cells may be cultured and the protein harvested according to methods known in the art.

The terms “expression vector” and “recombinant expression vector” as used herein refer to a recombinant DNA molecule containing a desired coding sequence and appropriate nucleic acid sequences necessary for the expression of the operably linked coding sequence in a particular host organism. The expression vector may comprise sequences encoding heterologous domains including, but not limited to, protein detection, purification or cleavage sequences that may be fused at the N- or C-terminus to the desired coding sequence, to yield a fusion protein. The present invention encompasses expression vectors that are integrated into host cell genomes, as well as episomal vectors. Suitable host cells for expressing S100 proteins, homologs or variants thereof include, but are not limited to, Escherichia coli, Bacillus subtilis, Lactococcus lactis, Saccharomyces cerevisiae, and Pichia pastoris. Each possibility represents a separate embodiment.

According to some embodiments, the S100 protein is expressed by a probiotic microorganism. Without being bound by any theory or mechanism of action, the expression of the proteins in probiotic microorganisms provides the advantages conferred by the probiotic microorganisms while also avoiding the necessity of purifying the proteins from the host cell and media. Probiotic host cells within the scope of the present invention include, but are not limited to, Lactobacillus acidophilus, Bifidobacterium bifidum, Streptococcus thermophilus, Lactobacillus rhamnosus, Lactobacillus plantarum, Bifidobacterium lactis, Lactobacillus casei, Lactobacillus brevis, Lactobacillus fermentum, Lactobacillus paracasei, Lactobacillus reuteri, Lactobacillus johnsonii, Lactobacillus gasseri, Lactobacillus crispatus, Lactobacillus jensenii, and Bifidobacterium longum. Each possibility represents a separate embodiment.

In some embodiments, the S100 protein is provided as a homodimer. In other embodiments, the S100 protein is provided as a multimer. The term “multimer” as used herein refers to a complex with two or more S100 proteins or homologs thereof. In an additional embodiment, the composition comprises an S100 protein or homolog thereof in combination with at least one other S100 protein or homolog thereof. In another embodiment, the S100 protein or homolog thereof is provided as a multimer with at least one other S100 protein or homolog thereof. In a particular embodiment, the composition comprises a combination of S100a8 and S100a9. In yet another particular embodiment, S100a8 and S100a9 are provided as the calprotectin or calgranulin A/B complex. Each possibility represents a separate embodiment.

Within the scope of the present invention is the use of a composition comprising at least one S100 protein as an anti-fungal or an anti-bacterial agent in a food or beverage product. As used herein, the terms “anti-fungal” and “anti-fungally effective” refer to substances or compositions that inhibit, prevent, reduce, hinder, or eliminate the growth of at least one strain of fungi associated with spoilage of food or beverages, such as yeast and/or mold. In some aspects and embodiments, it refers to the ability of the substance or composition comprising same to effectively inhibit the growth of at least one strain of a yeast including, but not limited to, Zygosaccharomyces rouxii, Saccharomyces cerevisiae, Pichia membranaefaciens, Candida crusei, Dekkera bruxellensis, Pichia anomala, Zygosaccharomyces baiii, Dekkera naardensis, and Candida albicans. Each possibility represents a separate embodiment. In other aspects and embodiments, it refers to the ability of the substance or composition comprising same to effectively inhibit the growth of at least one strain of a mold including, but not limited to, Byssochlamys nivea, Byssochlamys fulva, Neosartorya fischeri, Talaromyces harzanium, Fusarium solani, Aspergillus fumigatis, Aspergillus niger, Penicillium crustosum, Penicillium digitatum, Penicillium roqueforti, Fusarium oxysporum, and Mucor rouxii. Each possibility represents a separate embodiment.

As used herein, the terms “anti-bacterial” and “anti-bacterially effective” refer to substances or compositions that inhibit, prevent, reduce, hinder, or eliminate the growth of at least one strain of bacteria associated with spoilage of food or beverages. In some aspects and embodiments, it refers to the ability of the substance or composition to effectively inhibit the growth of at least one strain of bacteria including, but not limited to, Brochothrix thermosphacta, Carnobacterium spp., Lactobacillus spp., Lactococcus spp., Leuconostoc spp., Pediococcus spp., Stretococcus spp., Kurthia zopfii, Clostridium perfringens, Escherichia coli, Salmonella spp., Listeria monocytogenes, Enterobacter spp., and Weissella spp. Each possibility represents a separate embodiment.

The term “effective” as used herein refers to the amount of a substance or composition comprising same that is sufficient to inhibit the proliferation and/or growth of a yeast, mold or bacteria strain as defined hereinabove.

The term “proliferation” as used herein refers to an increase in microbial cell counts (typically by processes involving cell division). Since bacterial proliferation, rather than mere increase in cell mass without cell division, is usually of primary concern, and since under most circumstances of interest herein proliferation is accompanied by an increase in microbial biomass, the term “growth” is generally understood to mean “proliferation”, and the two terms are used interchangeably herein although it is recognized that different assays may measure either or both of these parameters. For example, optical density reflects biomass and does not specifically reflect cell number, whereas an assay based on detecting colonies formed from individual cells reflects cell number rather than biomass. In some embodiments, microbial proliferation may conveniently be determined if a 100-fold increase or greater in the number of the food spoilage microorganisms occurs in a food or beverage, after an initial inoculation level of about 10 colony forming units (cfu)/ml.

It will be understood by a person of skill in the art that certain food or beverages products are prone to contamination by particular bacteria, fungi, or mold. According to some embodiments, the composition comprising at least one S100 protein can be added to a food or beverage product so as to inhibit specific microorganisms that are associated with said food or beverage product based on the IC₉₀ value of the S100 protein. The term “IC₉₀” is defined as the in vitro concentration of the protein that is needed to inhibit 90% of growth of a given microorganism. According to one embodiment, the composition comprising psoriasin is added to a final concentration of at least about 0.6 μM thereby inhibiting Aspergillus flavus-induced spoilage. According to another embodiment, the composition comprising psoriasin is added to a final concentration of at least about 0.7 μM thereby inhibiting Candida albicans-induced spoilage. According to yet another embodiment, the composition comprising psoriasin is added to a final concentration of at least about 100 μM thereby inhibiting Escherichia coli-induced spoilage. According to yet an additional embodiment, the composition comprising psoriasin is added to a final concentration of at least about 75 μM thereby inhibiting Listeria monocytogenes-induced spoilage. According to yet another embodiment, the composition comprising psoriasin is added to a final concentration of at least about 50 μM thereby inhibiting Lactobacillus saeki-induced spoilage. According to another embodiment, the composition comprising psoriasin is added to a final concentration of at least about 45 μM thereby inhibiting Lactococcus lactis-induced spoilage. According to another embodiment, the composition comprising psoriasin is added to a final concentration of at least about 28 μM thereby inhibiting Enterobacter cloacae-induced spoilage. Thus, for example, psoriasin added to a final concentration of at least 100 μM (in the food or beverage) would advantageously inhibit spoilage induced by at least the following microorganisms: Aspergillus flavus, Candida albicans, Escherichia coli, Listeria monocytogenes, Lactobacillus saeki, Lactococcus lactis, and Enterobacter cloacae.

According to some embodiments, inhibiting microbial-induced spoilage comprises preventing the growth of microorganisms in or on the surface of the food or beverage product. According to some embodiments, inhibiting microbial-induced spoilage comprises eradicating or inactivating microorganisms in or on the surface of the food or beverage product. According to some embodiments, inhibiting microbial-induced spoilage comprises reducing the activity or metabolic rate of microorganisms in or on the surface of the food or beverage product. According to some embodiments, inhibiting microbial-induced spoilage comprises reducing the growth and reproduction of microorganisms in or on the surface of the food or beverage product.

As used herein, the term “spoilage” refers to the consequence of the microorganism (bacteria, yeast, and/or mold) growth in the product such as a food or beverage product for humans or animals. In some embodiments, the term “spoilage” refers to the consequence of pathogenic microorganism growth in the product such as a food or beverage product for humans or animals. The product components (such as food or beverage components) are utilized as growth substrates by the microorganism (such as fungi and/or bacteria) and are transformed into a vast array of metabolic end-products. In this way, the chemical, physical, and/or sensory properties of the product are changed.

Microorganism-induced spoilage becomes evident to the consumer in many ways, depending on the product: signs of food spoilage may include an appearance different from the food in its fresh form, such as a change in color, a change in texture, an unpleasant odor, or an undesirable taste. The item may become softer than normal, and if mold occurs, it is often visible externally on the item. Signs of beverage spoilage often further include enhancement in its turbidity. Spoilage microorganism can also produce toxins and other substances that are dangerous to the consumers. As used herein, the term “microorganism-induced spoilage” encompasses detectable changes in the chemical, physical and/or sensory characteristics of the food or beverage as disclosed herein, including with respect to its color, flavor, odor, consistency and/or turbidity, which would not otherwise occur in the food or beverage in the absence of said microorganism (e.g., fungi or bacteria).

According to some embodiments, the method for preserving food products comprises adding a composition comprising at least one S100 protein during the production process of the food product. According to some embodiments, the method for preserving food products comprises adding a composition comprising at least one S100 protein following the production process of the food product. According to some embodiments, the method for preserving food products comprises adding a composition comprising at least one S100 protein to the food product prior to sealing following its production. According to some embodiments, the method for preserving food products comprises coating the food product with a composition comprising at least one S100 protein. According to other embodiments, the method for preserving food products comprises coating the inner surface of the food product package with said composition. According to yet other embodiments, the method for preserving food products comprises spraying or washing the food product with said composition.

According to some embodiments, the food product comprises a water content of at least 0.1%, 0.5%, 1%, 2%, 5%, 10%, 20%, 30%, or 40%. Each possibility represents a separate embodiment. According to some embodiments, the food product comprises a water content of at least 5%. According to other embodiments, the food product comprises a water content of at least 10%. According to yet other embodiments, the food product comprises a water content of at least 20%.

According to some embodiments, the food or beverage products have a pH in the range of about 1 to about 12, including each value within the specified range. Thus, in some embodiments, the food or beverage products have a pH in the range of about 5 to about 10, including each value within the specified range. In some embodiments, the pH of the food or beverage product is about 1. In some embodiments, the pH of the food or beverage product is about 2. In some embodiments, the pH of the food or beverage product is about 3. In some embodiments, the pH of the food or beverage product is about 4. In some embodiments, the pH of the food or beverage product is about 5. In some embodiments, the pH of the food or beverage product is about 6. In some embodiments, the pH of the food or beverage product is about 7. In some embodiments, the pH of the food or beverage product is about 8. In some embodiments, the pH of the food or beverage product is about 9. In some embodiments, the pH of the food or beverage product is about 10. In some embodiments, the pH of the food or beverage product is about 11. In some embodiments, the pH of the food or beverage product is about 12.

According to some embodiments, the food or beverage products are characterized by having a divalent ion concentration of less than 50 mM, for example less than 40 mM, 30 mM, 20 mM, 10 mM, 5 mM, 2.5 mM, 1 mM, 0.5 mM, 0.1 mM, 0.05 mM, 10 μM, or 5 μM. Each possibility represents a separate embodiment. The term “divalent ion” as used herein refers to ions having a valency of 2. In some embodiments, the term “divalent ion” refers to a divalent cation with a valency of +2. Examples of divalent cations include, but are not limited to, Ca²⁺, Mg²⁺, Zn²⁺, Cu²⁺, Fe²⁺, Mn²⁺, Ni²⁺, and Co²⁺. Each possibility represents a separate embodiment. In certain embodiments, the food or beverage products have a divalent ion concentration of less than 1.2 μM. According to some embodiments, the food or beverage products have a divalent ion concentration of less than 1 μM. According to some embodiments, the food or beverage products have a divalent ion concentration of less than 0.8 μM. According to some embodiments, the food or beverage products have a divalent ion concentration of less than 0.6 μM. According to some embodiments, the food or beverage products have a divalent ion concentration of less than 0.4 μM. According to some embodiments, the food or beverage products have a divalent ion concentration of less than 0.2 μM. According to some embodiments, the food or beverage products have a divalent ion concentration of less than 0.1 μM. According to some embodiments, the food or beverage products have a divalent ion concentration of less than 0.05 μM. According to some embodiments, the food or beverage products have a divalent ion concentration of less than 0.01 μM. According to some embodiments, the food or beverage products have a divalent concentration of 0.2% w/w or less.

According to some embodiments, the food or beverages have a zinc ion concentration of less than 50 mM. According to other embodiments, the food or beverages have a zinc ion concentration of less than 10 mM. According to yet other embodiments, the food or beverages have a zinc ion concentration of less than 1 mM. According to certain embodiments, the food or beverages have a zinc ion concentration of less than 0.5 mM. According to additional embodiments, the food or beverages have a zinc ion concentration of less than 0.1 mM. According to various embodiments, the food or beverages have a zinc ion concentration of less than 0.05 mM. According to specific embodiments, the food or beverages have a zinc ion concentration of less than 10 μM. According to yet other specific embodiments, the food or beverages have a zinc ion concentration of less than 5 μM. According to further embodiments, the food or beverage products have a zinc ion concentration of less than 1.2 μM. According to some embodiments, the food or beverage products have a zinc ion concentration of less than 1 μM. According to some embodiments, the food or beverage products have a zinc ion concentration of less than 0.8 μM. According to some embodiments, the food or beverage products have a zinc ion concentration of less than 0.6 μM. According to some embodiments, the food or beverage products have a zinc ion concentration of less than 0.4 μM. According to some embodiments, the food or beverage products have a zinc ion concentration of less than 0.2 μM. According to some embodiments, the food or beverage products have a zinc ion concentration of less than 0.1 μM. According to some embodiments, the food or beverage products have a zinc ion concentration of less than 0.05 μM. According to some embodiments, the food or beverage products have a zinc ion concentration of less than 0.01 μM. According to one embodiment, the food or beverage products have a zinc ion concentration of less than 0.1% w/w.

According to some embodiments, the molar ratio between the divalent ion concentration and the S100 protein in the food or beverage is about 1:1 or less, for example 1:2, 1:5, 1:10, 1:20, 1:30, 1:40, 1:50, 1:60, 1:70, 1:80, 1:90, 1:100, 1:150, 1:200, 1:250; 1:300, 1:350, 1:400, 1:450, 1:500, 1:550, 1:600, 1:650, 1:700, 1:750, 1:800, 1:850, 1:900, 1:950, 1:1000 or less. Each possibility represents a separate embodiment.

According to some embodiments, the molar ratio between the zinc ion concentration and the S100 protein in the food or beverage is about 1:1 or less, for example 1:2, 1:5, 1:10, 1:20, 1:30, 1:40, 1:50, 1:60, 1:70, 1:80, 1:90, 1:100, 1:150, 1:200, 1:250; 1:300, 1:350, 1:400, 1:450, 1:500, 1:550, 1:600, 1:650, 1:700, 1:750, 1:800, 1:850, 1:900, 1:950, 1:1000 or less. Each possibility represents a separate embodiment.

According to some embodiments, the method for preserving food or beverage products comprises providing an S100 protein at a concentration of at least 50 nM. According to some embodiments, the method for preserving food or beverage products comprises providing an S100 protein at a concentration of at least 0.1 μM. According to some embodiments, the method for preserving food or beverage products comprises providing an S100 protein at a concentration of at least 1 μM. According to some embodiments, the method for preserving food or beverage products comprises providing an S100 protein at a concentration of at least 5 μM. According to some embodiments, the method for preserving food or beverage products comprises providing an S100 protein at a concentration of at least 10 μM. According to some embodiments, the method for preserving food or beverage products comprises providing an S100 protein at a concentration of at least 25 μM. According to some embodiments, the method for preserving food or beverage products comprises providing an S100 protein at a concentration of at least 50 μM. According to some embodiments, the method for preserving food or beverage products comprises providing an S100 protein at a concentration of at least 75 μM. According to some embodiments, the method for preserving food or beverage products comprises providing an S100 protein at a concentration of at least 100 μM. According to some embodiments, the method for preserving food or beverage products comprises providing an S100 protein at a concentration of at least 250 μM. According to some embodiments, the method for preserving food or beverage products comprises providing an S100 protein at a concentration of about 500 μM. It is to be understood, that when the S100 protein is indicated to be “provided” at a particular concentration, it is meant that the amount provided is such that the concentration of the S100 protein in the final product (food, beverage, or an intermediate or premix thereof that is intended for storage) is as indicated in the particular concentration. For example, the S100 protein may be provided in an amount of 0.01-10% (w/w), including each value within the specified range. Suitable weight percentages of the S100 protein incorporated into the food or beverage product include, but are not limited to, about 0.05-5% (w/w), about 0.1-2.5% (w/w), and about 0.1-1% (w/w), including each value within the specified ranges.

According to some embodiments, the method for preserving food or beverage products comprises providing an S100 protein at a concentration of about 50 nM. According to some embodiments, the method for preserving food or beverage products comprises providing an S100 protein at a concentration of at most 0.1 μM. According to some embodiments, the method for preserving food or beverage products comprises providing an S100 protein at a concentration of at most 1 μM. According to some embodiments, the method for preserving food or beverage products comprises providing an S100 protein at a concentration of at most 5 μM. According to some embodiments, the method for preserving food or beverage products comprises providing an S100 protein at a concentration of at most 10 μM. According to some embodiments, the method for preserving food or beverage products comprises providing an S100 protein at a concentration of at most 25 μM. According to some embodiments, the method for preserving food or beverage products comprises providing an S100 protein at a concentration of at most 50 μM. According to some embodiments, the method for preserving food or beverage products comprises providing an S100 protein at a concentration of at most 75 μM. According to some embodiments, the method for preserving food or beverage products comprises providing an S100 protein at a concentration of at most 100 μM. According to some embodiments, the method for preserving food or beverage products comprises providing an S100 protein at a concentration of at most 250 μM. According to some embodiments, the method for preserving food or beverage products comprises providing an S100 protein at a concentration of at most 500 μM.

According to the principles of the present invention, the composition comprising the S100 protein such as psoriasin and analogs or variants thereof does not adversely affect the organoleptic properties of the food and beverage products. The term “organoleptic properties” refers to the aspects of food and beverages that create an individual experience via the senses, including, but not limited to, taste, sight, smell, and touch. Thus, a food or a beverage product, irrespective of the presence of the preservative agent according to the principles of the present invention, is perceived by subjects to have the same organoleptic properties. According to some embodiments, the food product comprises at least 50 nM of the at least one S100 protein, preferably about 100 nM to about 500 μM of at least one S100 protein while not affecting the organoleptic properties of the product, including taste, smell, flavor, savor, odor, aroma, texture, and consistency. Each possibility represents a separate embodiment.

According to some embodiments, preservation of the food or beverage product comprises an effective amount of at least one S100 protein that provides a shelf life of at least 1 day. According to some embodiments, preservation of the food or beverage product comprises an effective amount of at least one S100 protein that provides a shelf life of at least 1 week. According to some embodiments, preservation of the food or beverage product comprises an effective amount of at least one S100 protein that provides a shelf life of at least 2 weeks. According to some embodiments, preservation of the food or beverage product comprises an effective amount of at least one S100 protein that provides a shelf life of at least 3 weeks. According to some embodiments, preservation of the food or beverage product comprises an effective amount of at least one S100 protein that provides a shelf life of at least 1 month. According to some embodiments, preservation of the food or beverage product comprises an effective amount of at least one S100 protein that provides a shelf life of at least 2 months. According to some embodiments, preservation of the food or beverage product comprises an effective amount of at least one S100 protein that provides a shelf life of at least 3 months. According to some embodiments, preservation of the food or beverage product comprises an effective amount of at least one S100 protein that provides a shelf life of at least 6 months. According to some embodiments, preservation of the food or beverage product comprises an effective amount of at least one S100 protein that provides a shelf life of at least 9 months. According to some embodiments, preservation of the food or beverage product comprises an effective amount of at least one S100 protein that provides a shelf life of at least 1 year. According to some embodiments, the addition of a composition comprising at least one S100 protein to a food or beverage product extends the shelf life of the product by at least 1.5 to 10-fold compared to the shelf life of the food or beverage product without any added preservatives.

According to some embodiments, preservation of the food or beverage product comprises prevention from spoiling for at least 1 day. According to some embodiments, preservation of the food or beverage product comprises prevention from spoiling for at least 1 week. According to some embodiments, preservation of the food or beverage product comprises prevention from spoiling for at least 2 weeks. According to some embodiments, preservation of the food or beverage product comprises prevention from spoiling for at least 3 weeks. According to some embodiments, preservation of the food or beverage product comprises prevention from spoiling for at least 1 month. According to some embodiments, preservation of the food or beverage product comprises prevention from spoiling for at least 2 months. According to some embodiments, preservation of the food or beverage product comprises prevention from spoiling for at least 3 months. According to some embodiments, preservation of the food or beverage product comprises prevention from spoiling for at least 6 months. According to some embodiments, preservation of the food or beverage product comprises prevention from spoiling for at least 9 months. According to some embodiments, preservation of the food or beverage product comprises prevention from spoiling for at least 1 year.

According to some embodiments, preservation of the food or beverage product comprises inhibition of microbial growth for at least 1 day. According to some embodiments, preservation of the food or beverage product comprises inhibition of microbial growth for at least 1 week. According to some embodiments, preservation of the food or beverage product comprises inhibition of microbial growth for at least 2 weeks. According to some embodiments, preservation of the food or beverage product comprises inhibition of microbial growth for at least 3 weeks. According to some embodiments, preservation of the food or beverage product comprises inhibition of microbial growth for at least 1 month. According to some embodiments, preservation of the food or beverage product comprises inhibition of microbial growth for at least 2 months. According to some embodiments, preservation of the food or beverage product comprises inhibition of microbial growth for at least 3 months. According to some embodiments, preservation of the food or beverage product comprises inhibition of microbial growth for at least 6 months. According to some embodiments, preservation of the food or beverage product comprises inhibition of microbial growth for at least 9 months. According to some embodiments, preservation of the food or beverage product comprises inhibition of microbial growth for at least 1 year.

Compositions and methods in accordance with the invention are useful in preventing spoilage and improving the shelf life of nutritional edible compositions such as food and beverages. Thus, in certain aspects and embodiments, a food or a beverage product is provided which comprises an effective amount of a preservative being an S100 protein as disclosed herein.

The term “food” as used herein is meant to cover edible products that are suitable for human as well as animal consumption. Preferably, the food product is suitable for, and designed for, human consumption. The edible products are mainly nutritive and/or enjoyable products of the food industry requiring preservation for their storage between the time of production and eventual use.

Food which may be subject to the methods and uses described herein may include any manufactured, harvested, farmed or processed food, food stuff, produce or product. The term food may further be applied to any fresh produce as well as prepared and/or processed produce which has been stored or prepared for storage. In some embodiments, the term “food” encompasses solid and semi-solid food compositions for human consumption.

Exemplary food products within the scope of the present invention include, but are not limited to, meat or poultry products, substitute meat or poultry products, fish products, fish substitute products, dairy products, substitute dairy products, bakery products, fruit and vegetable dishes, confectionaries, snack foods, soups, sauces, spreads, and dressings. Each possibility represents a separate embodiment.

According to some embodiments, the S100 protein is used as a preservative in baked goods, such as breads and pastries. According to some embodiments, the S100 protein is used as a preservative in dairy products, such as milk, cheese, and yogurt. According to some embodiments, the S100 protein is used as a preservative in substitute milk or dairy products, such as soy-based products. According to some embodiments, the S100 protein is used as a preservative in meats, such as beef, poultry, and pork. According to some embodiments, the S100 protein is used as a preservative in products, such as fruits and vegetables. According to some embodiments, the S100 protein is used as a preservative in chickpeas. According to some embodiments, the S100 protein is used as a preservative in snack foods, such as chips and crackers. According to some embodiments, the S100 protein is used as a preservative in sauces and condiments, such as ketchup and mayonnaise. According to some embodiments, the S100 protein is used as a preservative in soups and broths. According to some embodiments, the S100 protein is used as a preservative in ready-to-eat meals, such as frozen dinners and deli meats. According to some embodiments, the S100 protein is used as a preservative in dried foods, such as trail mix and jerky.

The term “beverage” as used herein describes processed or unprocessed liquid items produced for human or animal consumption (e.g., juices, coffee beverages, teas, milk, milk alternatives, beer, wine, cocktails, liqueurs, spirits, cider, soft drinks, flavored water, energy drinks or the like). In some embodiments, the term “beverage” encompasses aqueous liquid compositions for human consumption.

Exemplary beverages within the scope of the present invention include, but are not limited to, soft drinks, juices and nectars, milk and milk-based drinks, substitute milk and milk-based drinks, hot drinks, and alcoholic drinks. According to some embodiments, the S100 protein is used as a preservative in beverages, such as juices, sports drinks, or alcoholic beverages. According to some embodiments, the S100 protein is used as a preservative in beetroot juice. According to some embodiments, the S100 protein is used as a preservative in apple juice.

In some embodiments, the terms “food” and “beverage” further encompass intermediates and pre-mixes thereof. For example, adding a composition comprising at least one S100 protein to the food or beverage may encompass applying to, or admixing said S100-containing composition with, an intermediate or premix of said food or beverage during its manufacturing process.

In a particular embodiment, said manufacturing process comprises heat processing e.g., by cooking, baking, frying, boiling, grilling, steaming, or combinations thereof, and said intermediate or premix is a pre- or partly-cooked (or baked, fried etc.) intermediate or premix of said food product. As disclosed herein, psoriasin was remarkably found to maintain its antimicrobial properties following exposure to thermal conditions typically associated with heat processing steps used in the food industry (such as cooking). For example, the heat processing step may comprise exposure to temperatures of up to 84° C. or 90° C. for up to one hour (e.g., temperatures of 70° C., 80° C., and 90° C. for periods of 15, 30, or 60 minutes). In other embodiments, said manufacturing process comprises lyophilization or oven-drying. Each possibility represents a separate embodiment of the invention.

It is to be understood that the terms “food” and “beverage” are not intended to encompass edible pharmaceutical or veterinary formulations.

According to some embodiments, the S100 protein is used as a preservative of a cell culture medium, for example in food applications or for other purposes such as, but not limited to, various cell culture assays used in research, diagnostics, etc.

According to some embodiments, the food or beverage product comprising an effective amount of at least one S100 protein is stored at a temperature between 0° C. and room temperatures. According to some embodiments, the food or beverage product comprising an effective amount of at least one S100 protein is stored at a temperature between 0° C. and 30° C., including each value within the specified range. According to some embodiments, the food or beverage product comprising an effective amount of at least one S100 protein is stored in a dry, cool, and dark place. According to some embodiments, the food or beverage product comprising an effective amount of at least one S100 protein is stored in a refrigerator. According to some embodiments, the food or beverage product comprising an effective amount of at least one S100 protein is stored in a pantry or cupboard. According to some embodiments, the food or beverage product comprising an effective amount of at least one S100 protein is stored in an airtight container. According to some embodiments, the food or beverage product comprising an effective amount of at least one S100 protein is stored in a container with controlled temperature and humidity to preserve freshness.

In some embodiments, the food or beverage is substantially resistant to microbial proliferation/spoilage for at least 2, 5, 7, 10, or 14 days at temperatures of 4-40° C., including each value within the specified range. In other embodiments, the food or beverage is substantially resistant to microbial proliferation/spoilage for at least 7 days at temperatures of 4-30° C., including each value within the specified range. In yet other embodiments, resistance to microbial proliferation/spoilage comprises the presence of less than 1×10⁶, 1×10⁵, 1×10⁴, or 1×10³ CFU of pathogenic microorganisms per gram of the food or beverage product following storage for at least 2, 5, 7, 10, or 14 days at temperatures of 4-40° C. In further embodiments, resistance to microbial proliferation/spoilage comprises the presence of less than 1×10⁶, 1×10⁵, 1×10⁴, or 1×10³ CFU of pathogenic microorganisms per gram of the food or beverage product following storage for at least 7 days at temperatures of 4-30° C.

While the S100 protein can be added to the food or beverages as is, in some embodiments, it is incorporated into a composition which further comprises edible additive(s). According to some embodiments, the composition comprises at least 5% w/w, at least 10% w/w, at least 20% w/w, at least 35% w/w, at least 50% w/w, at least 60% w/w, at least 75% w/w, or at least 90% w/w of at least one S100 protein based on the total weight of the composition. Each possibility represents a separate embodiment of the invention.

According to various aspects and embodiments, the composition is in the form of a solution, a paste, a gel or a powder. Each possibility represents a separate embodiment. According to certain embodiments, the composition is in the form of an aqueous or a non-aqueous solution suitable for incorporation into liquid or semi-solid food or beverage products. According to other embodiments, the composition is in the form of a gel or a paste suitable for incorporation into semi-solid or solid food products. According to some embodiments, the composition is in the form of a powder, which may be suitable for incorporation into semi-solid or solid food products or for dissolution or suspension in a beverage product.

According to some embodiments, the composition is used as a coating on the surface of a food product to provide an antimicrobial barrier and extend its shelf life. Thus, the composition may be sprayed or applied to the food product to form a coating. According to other embodiments, the composition is incorporated within a food product.

According to other embodiments, the composition is added to a food product as an antimicrobial agent during the production process. According to some embodiments, the composition is incorporated into a food product using a spraying technique to distribute it evenly throughout the product. According to some embodiments, the composition is added to a food packaging material to provide an antimicrobial barrier and extend shelf life.

Within the scope of the present inventive are edible additives that may be incorporated into the composition including, but not limited to, antioxidants, flavoring agents, nutrients including vitamin supplements and mineral supplements, sweeteners, thickeners, colorants, emulsifiers, antifoaming agents, and a mixture or combination thereof. Each possibility represents a separate embodiment.

According to certain aspects and embodiments, the products (e.g., food or beverage) and compositions of the invention are substantially devoid of chemical preservatives. In another embodiment, said product or composition is substantially devoid of benzoate-, propionate-, sorbate-, nitrate-, nitrite-, and sulfite-based preservatives. In another embodiment, said product or composition is substantially devoid of polyhydroxy alcohols, and of natural antimycotic and bacteriostatic agents other than the S100 protein. In another embodiment, resistance to spoilage is maintained in the absence of product sterilization, pasteurization or modified atmospheric packaging. In another embodiment, the S100 protein is used as a sole preservative. In another embodiment, said food or beverage comprises the S100 protein as the sole preservative.

While the S100 protein can be used as a single preservative in the food or beverage product, it may also be provided in combination with at least one additional ingredient known to be useful as a food or beverage preservative. Additional preservatives within the scope of the present invention are selected from the group consisting of chemical preservatives, natural preservatives, polyhydroxy alcohols, antimycotic agents and bacteriostatic agents, wherein each possibility represents a separate embodiment of the invention. Exemplary additional preservatives include, but are not limited to, nisin, potassium sorbate, sodium benzoate, sodium nitrate, sodium nitrite, benzoic acid, and a mixture or combination thereof. Each possibility represents a separate embodiment. In one embodiment, the food or beverage product comprises a combination of the S100 protein with nisin. In accordance with these embodiments, the products and compositions of the invention contain the S100 protein, such as psoriasin or a homolog thereof, and nisin as sole preservatives. The combination of preservatives can be included within a single composition as well as in two separate compositions that are admixed in the food or beverage product. In some embodiments, the combination provides an additive effect. In other embodiments, the combination provides a synergistic effect whereby the amount of each of the preservatives is lower while a sufficient desirable inhibition of bacterial and fungal proliferation is nonetheless achieved.

The compositions of the present invention can be prepared as is known in the art, for example by mixing, filtering, heating/cooling, drying, etc.

As used herein, the term “and/or” is intended to include any and all combinations of one or more of the associated listed items, as well as the lack of combinations when interpreted in the alternative (“or”).

As used herein, the term “consists essentially of” (and grammatical variants thereof), as applied to the compositions and methods of the present disclosure, means that the compositions/methods may contain additional components so long as the additional components do not materially alter the composition/method.

As used herein, the terms “comprise”, “comprises”, “comprising”, “contain”, “include”, “includes”, and “including” specify the presence of stated features, steps, operations, elements and/or components, but do not preclude the presence or addition of one or more other features, steps, operations, elements, components and/or groups thereof.

As used herein, the term “about” when used in reference to a measurable value such as an amount of mass, concentration, time, temperature and the like, is meant to encompass variations of 0.1%, 0.25%, 0.5%, 0.75%, 1%, 1.5%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19% or 20% of the specified amount. Unless otherwise indicated, all numerical values in the specification are to be understood as being modified by the term “about”. The term “approximately” is synonymous with the term “about”.

As used herein, the singular forms “a”, “an”, and “the” include plural forms unless the context clearly dictates otherwise.

### EXAMPLES

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### Example 1. Materials and Methods

### Recombinant Psoriasin:

Recombinant psoriasin containing a histidine tag was used. The expression vector for the His-psoriasin gene was pET-28a. His-psoriasin gene sequence was synthesized and optimized for E. coli. The DNA coding frame is set forth in SEQ ID NO: 10:

ATGGGCAGCAGCCATCATCATCATCATCACAGCAGCGGCCTGGTGCCGCGC
GGCAGCCATATGAGCAACACCCAGGCGGAGCGTAGCATCATTGGTATGATC
GATATGTTCCACAAGTACACCCGTCGTGACGATAAGATTGAGAAACCGAGC
CTGCTGACCATGATGAAAGAAAACTTCCCGAACTTTCTGAGCGCGTGCGAT
AAGAAAGGCACCAACTACCTGGCGGACGTGTTTGAGAAGAAAGACAAGAA
CGAAGATAAGAAAATCGACTTCAGCGAATTTCTGAGCCTGCTGGGTGATAT
TGCGACCGACTATCACAAACAGAGCCACGGCGCGGCGCCGTGCAGCGGTGG
CAGCCAATAA.

The amino acid sequence is set forth in SEQ ID NO: 11:

MGSSHHHHHHSSGLVPRGSHMSNTQAERSIIGMIDMFHKYTRRDDKIEK
PSLLTMMKENFPNFLSACDKKGTNYLADVFEKKDKNEDKKIDFSEFLSL
LGDIATDYHKQSHGAAPCSGGSQ.

### Preparation of Fungi Stock Samples:

A. flavus A11 spores were seeded on 10 cm plates of YAG-agarose for 3-4 days in a humidified incubator at 30° C. After sporulation, fresh spores were collected with 5 ml DDW+0.2% Tween. Spores were then centrifuged at room temperatures (5 min, 4,000 RPM), and suspended in 5 ml DDW. The suspension was termed “A. flavus fresh stock”.

A. flavus fresh stock was diluted ×1000 using DDW, and the spores were counted using a cytometer to determine the stock spores' concentration. A. flavus fresh stock was used for one week after spore production before disposal.

C. albicans were seeded on 10 cm plates of YAG-agarose for 1-2 days in a humidified incubator at 30° C. C. albicans colonies were used for 48 hours after their appearance before disposal.

### YAG-Agarose Plates Preparation:

YAG-agarose mixture was prepared according to the following recipe:

Yeast extract (5 g/L), dextrose (10 g/L), 1M MgSO₄ (10 ml/L), trace elements solution (1 ml/L), vitamin mix (2 ml), and agarose (15 g/L).

### Trace Elements Solution:

H₃BO₃ (0.4 g/L), CuSO₄*5H₂O (0.4 g/L), iron-chloride*4H₂O (0.8 g/L), MnCl₂ (0.8 g/L), NaMoO₄*2H₂O (0.8 g/L), and ZnSO₄*7H₂O (8 g/L).

The solution was titrated with HCl until the brown murky solution turned clear and yellow. Trace elements solution was then sterile filtered through 0.2 μm, and kept in the dark.

### Vitamin Mix (Stored at 4° C.):

p-aminobenzoic acid (1 g/L), nisin (1 g/L), pyridoxine (1 g/L), riboflavin (1 g/L), thiamine HCl (1 g/L), choline HCl (1 g/L), and d-biotin (2 g/L).

The Vitamin Mix solution was stored in the dark at 4° C. after autoclaving.

The YAG-agarose mixture was prepared, then autoclaved for 15 minutes at 120° C. followed by cooling to about 50° C. Chloramphenicol (34 μg/μl) and tetracycline (12.5 μg/μl) were then added. The mixture was poured into 10 cm Petri dishes—30 ml/plate.

Dose-Response Assay in 96 Well Plates with his-Psoriasin:

RPMI-MOPS (RPMI Powder, 165 mM MOPS, and Pen/Strep solution (x100)) was inoculated with either 50,000 spores/ml of A. flavus, or 1 colony/10 ml of C. albicans. The inoculated RPMI-MOPS was poured into a Nunclone™ coated 96-well plate (100 μl per well), with the different treatments and controls. The 96-well plate was then incubated in a shaker/incubator plate-reader at 30° C. where the absorbance (600 nm) was monitored and measured every 10 minutes.

In Example 4, several ZnCl₂ concentrations were added to 1 μM of His-psoriasin.

In Example 5, RPMI-MOPS was titrated to the different pH levels using 1M NaOH solution (RMPI-MOPS, initial pH ~4).

### Juice Preparations at Different pH Conditions:

Natural beetroot and apple juice without preservatives, was diluted ×0.5 with PBS×1 to avoid high background absorbance. The juice was titrated to pH=7.4 with 1M NaOH, inoculated with C. albicans (1 colony/10 ml), treated with 40 μM and 400 μM His-psoriasin, and monitored with the same measuring program as the RPMI-MOPS experiments.

### Chickpeas Assay Preparation and Addition of Psoriasin:

Sterilized and frozen chickpeas (100 g) were boiled for 15 minutes and ground using a blender. The ground chickpeas were treated with chloramphenicol (34 μg/μl) and tetracycline (12.5 μg/μl) to prevent microbial growth. The chickpeas were then inoculated with 500 spores/g of A. flavus and divided into groups of 7 g, and each group was treated with 7 ml of PBS×1 with different His-psoriasin concentrations to reach final concentrations of 0 μM, 50 μM, 100 μM, and 200 μM. The different groups were then divided into 1 g of treated and inoculated chickpeas in 6 well plates (1 g/well) and incubated in a humidified incubator at 30° C. Every day, 1 g of treated chickpeas from each group was diluted in PBS×1 and seeded on YAG-agarose plates to count colonies and calculate the fungi development through time.

For the visual evaluation of the treated/non-treated and inoculated/not-inoculated samples, the samples were prepared in the same way, but incubated at room temperatures and divided into groups of 3 g each.

### Example 2. Recombinantly Expressed His-Psoriasin Inhibits Aspergillus flavus Growth

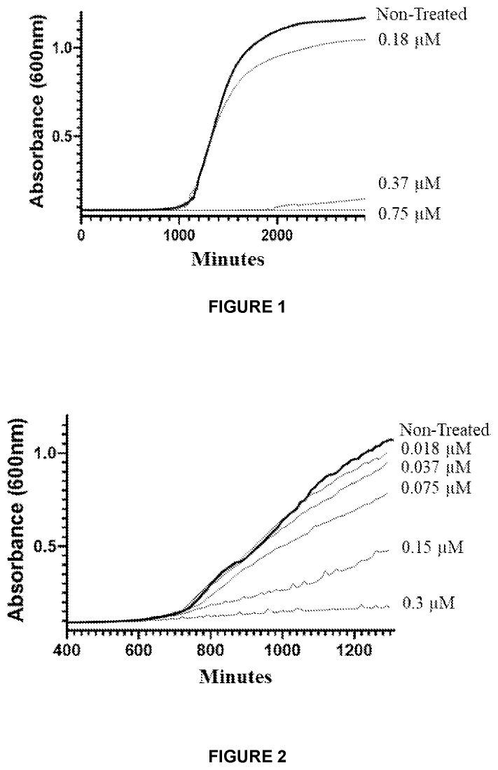

In order to evaluate the ability of recombinant His-psoriasin to inhibit the growth of Aspergillus flavus, 5,000 spores were incubated in a RPMI-MPS medium with variable concentrations of psoriasin added to each well. Fungi growth was monitored using an absorbance plate reader every 10 minutes at 600 nm. No apparent growth was measured in psoriasin concentrations higher than 375 nM for A. flavus (FIG. 1).

### Example 3. Recombinantly Expressed his-Psoriasin Inhibits Candida albicans Growth

In order to evaluate the ability of recombinant His-psoriasin to inhibit the growth of Candida albicans, a single colony/10 ml was incubated in a RPMI-MOPS medium with variable concentrations of psoriasin added to each well. Fungi growth was monitored using an absorbance plate reader every 10 minutes at 600 nm. No apparent growth was measured in psoriasin concentrations higher than 300 nM for C. albicans (FIG. 2).

### Example 4. Complementation of the Medium with Zinc Ions Retains Fungal Growth

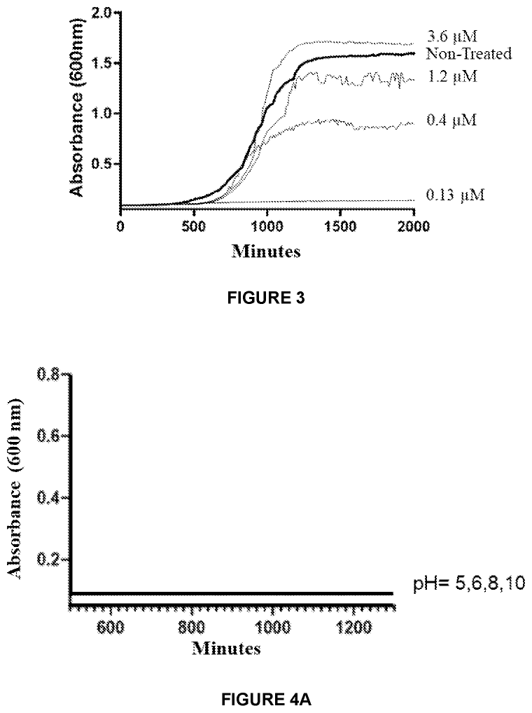

In order to test the effect of zinc ions on the ability of psoriasin to inhibit fungal growth, Candida albicans was incubated in a RPMI-MOPS medium in the presence of 1 μM psoriasin with variable concentrations of ZnCl₂. FIG. 3 shows that above 1.2 μM ZnCl₂, the fungi retained their full ability to grow.

### Example 5. Recombinant his-Psoriasin is Effective in a Broad pH Range

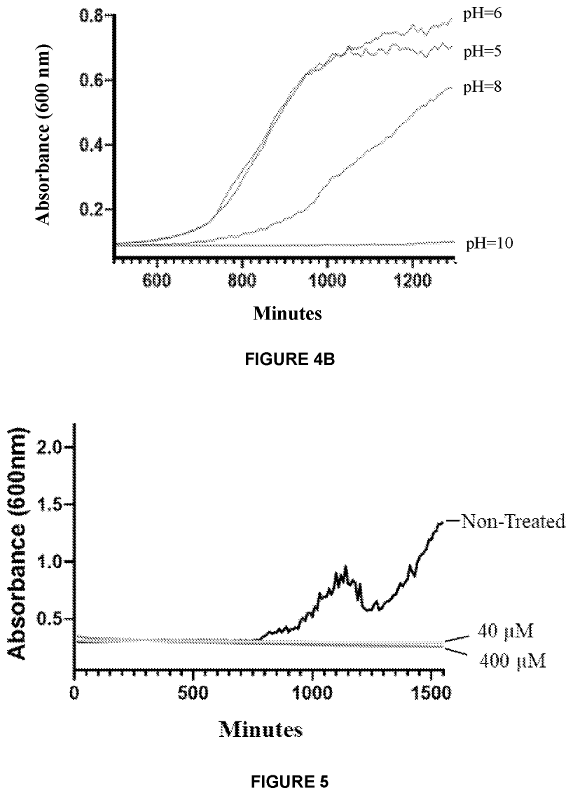

Candida albicans was incubated in a RPMI-MOPS medium in the presence of 10 μM His-psoriasin at variable pHs. His-psoriasin was shown to prevent C. albicans proliferation at all the tested pH levels (FIG. 4A). In contrast, C. albicans incubated in a RPMI-MOPS medium without His-psoriasin proliferated at pH<8 but did not grow at pH>8 (FIG. 4B). Accordingly, effective anti-fungal activity of His-psoriasin can be obtained also at pH levels that are lower than pH=8.

### Example 6. His-Psoriasin Inhibits Fungal Growth in Juice

In order to evaluate the effect of His-psoriasin on fungal growth in juice, natural apple and beetroot juices were inoculated without any preservatives with C. albicans. The samples were titrated to pH=7 and treated with 40 μM and 400 μM of recombinant His-psoriasin. The samples were placed in a 96 well-plate and absorbance at 600 nm was monitored vs. time. The fungi in the treated juice were not able to proliferate (FIG. 5).

### Example 7. His-Psoriasin Inhibits Fungal Growth in Chickpea Paste

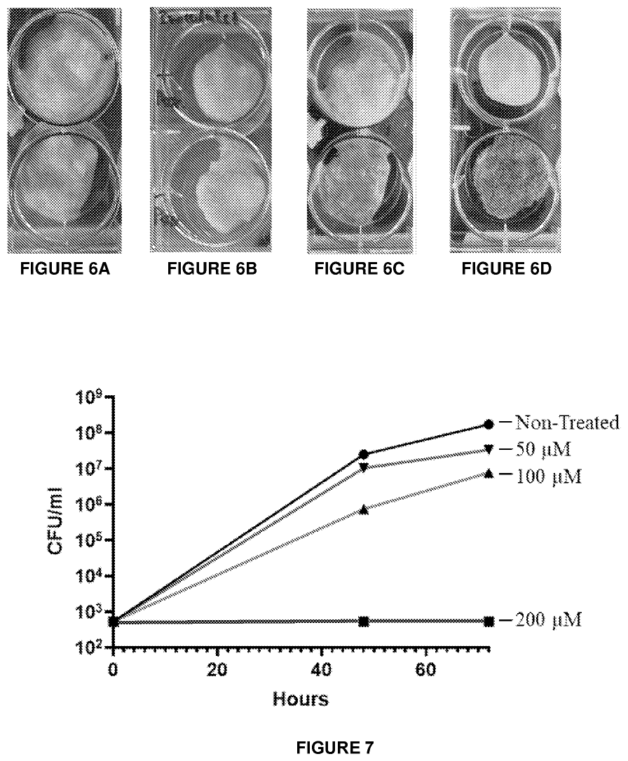

Chickpeas were boiled and ground and then treated with a combination of chloramphenicol and tetracycline antibiotics (to eliminate bacterial growth) at final concentrations of 34 μg/μl and 12.5 μg/μl, respectively. Samples were divided into ‘inoculated with Aspergillus flavus’ and ‘non-inoculated’, and ‘treated’ and ‘non-treated’ with 180 μM His-psoriasin. All samples were placed in 20° C. Even after 10 days, the samples that were treated with His-psoriasin did not show any signs of fungal growth (FIGS. 6A-6D).

In a follow-up experiment, inoculated chickpea paste samples were treated with three different recombinant His-psoriasin concentrations, namely 50 μM, 100 μM, and 200 μM, and incubated at 30° C. Fungal load count was performed on YAG-agarose plates with antibiotics (chloramphenicol (34 μg/μl) and tetracycline (12.5 μg/μl)) to prevent bacterial growth after 48 and 72 hours. No fungi had developed in the sample treated with 200 μM and reduced growth was observed at lower concentrations of His-psoriasin (FIG. 7).

### Example 8. Psoriasin has Antibacterial Activity and Synergistic Effect with Nisin

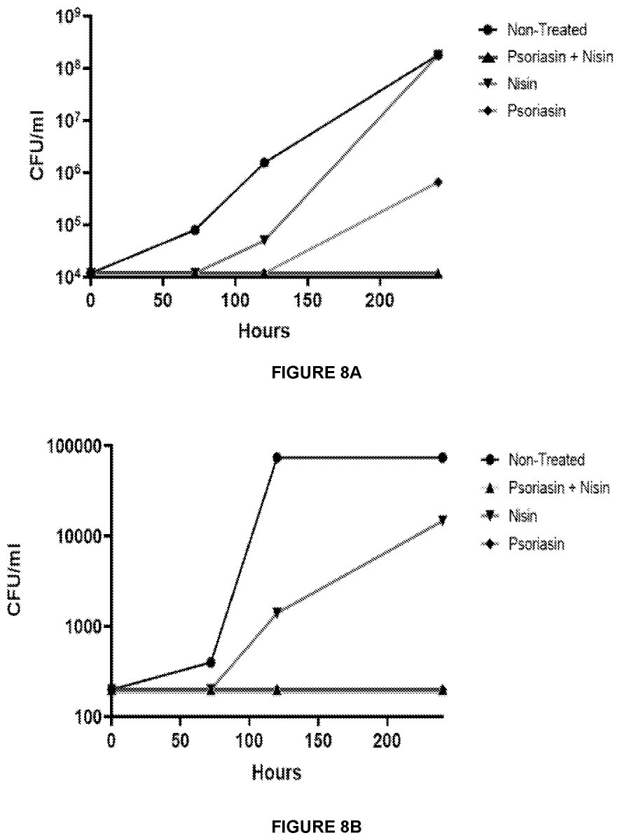

The ability of psoriasin to inhibit bacterial and fungal growth, with and without nisin was evaluated. Commercial plant-based ground meat (soy protein) was divided into 4 groups, each containing 5 grams of soy protein. The sample designated as “non-treated” contained 5 g of soy protein in 7.5 ml of PBS×1. The sample designated as “psoriasin” contained 5 g of soy protein in 7.5 ml of PBS×1 with 0.65% w/w of His-psoriasin. The sample designated as “nisin” contained 5 g of soy protein in 7.5 ml PBS×1 with 1.5 mg of nisin. The combined treatment group (“psoriasin+nisin”) contained 5 g of soy protein with both his-psoriasin and nisin at the same concentrations. The samples were incubated in 6c, and the microbial load was evaluated by seeding the different test groups on LB-agarose plates containing no antibiotics or on YAG-agarose plates with the antibiotics. Psoriasin alone inhibited microbial growth as evident by the reduction of microbial load, and the combination of psoriasin with nisin completely prevented microbial growth (FIG. 8A). In plates treated with antibiotics, psoriasin and the combination of psoriasin with nisin inhibited fungal/yeast growth (FIG. 8B). Thus, psoriasin is effective against both fungi and bacteria and has a synergistic effect when combined with nisin.

### Example 9. Psoriasin Inhibits the Growth of Microbes Isolated from Soy Protein

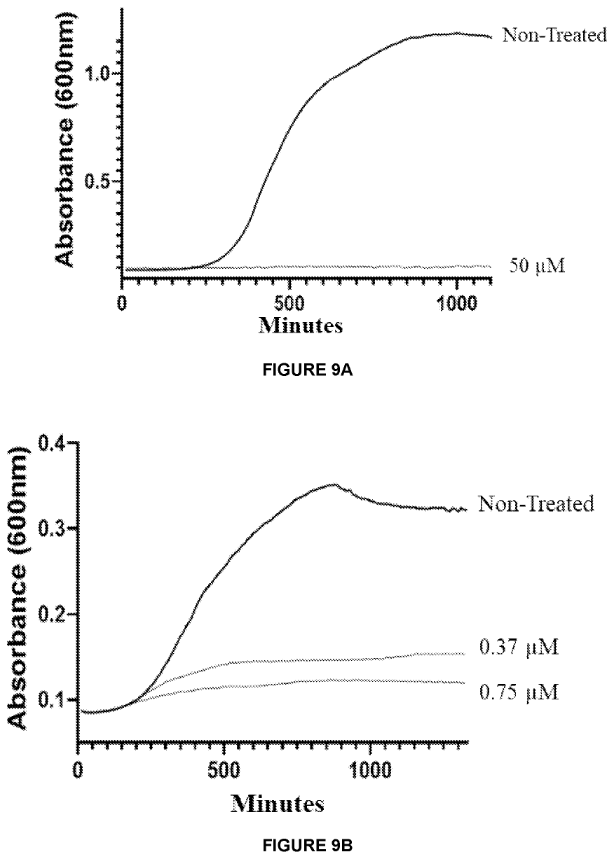

Psoriasin was applied to a microbial sample isolated from soy protein that was incubated in RPMI or LB medium, with no addition of external antibiotics. Liquid RPMI 1640 (5 ml) medium w/o Pen/strep antibiotics were inoculated with a colony that grew on an LB agarose plate from Example 8. The inoculated medium was incubated in a 37° C. shaker incubator overnight. Only the medium without antibiotics became turbid as a result of the endogenic bacterial growth. The isolated bacteria were used in dose-response experiments in RPMI 1640 and LB. Microbial growth was monitored in a 96-well plate by reading the absorbance at 600 nm every 10 minutes while adjusting the temperature to 37° C. In the rich LB medium, psoriasin was effective at a concentration of 50 μM (FIG. 9A). In RPMI, psoriasin was effective in concentrations below 1 μM (FIG. 9B).

### Example 10. Recombinant Proteins S100a8 and S100a9 Inhibit Growth of E. coli BL21 Cells

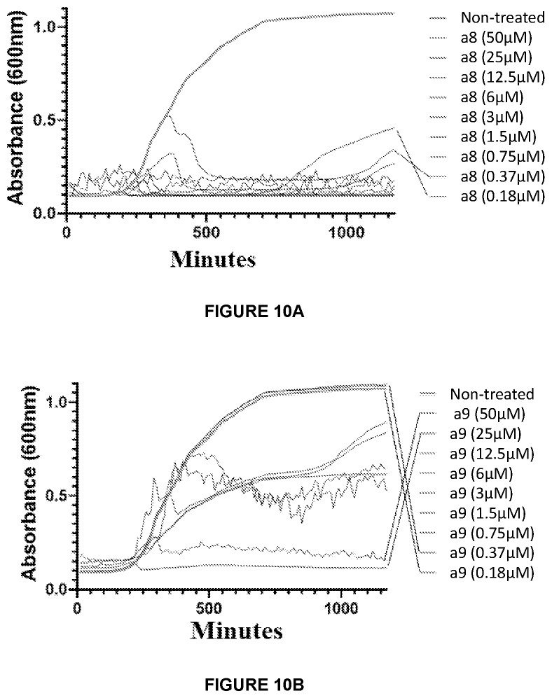

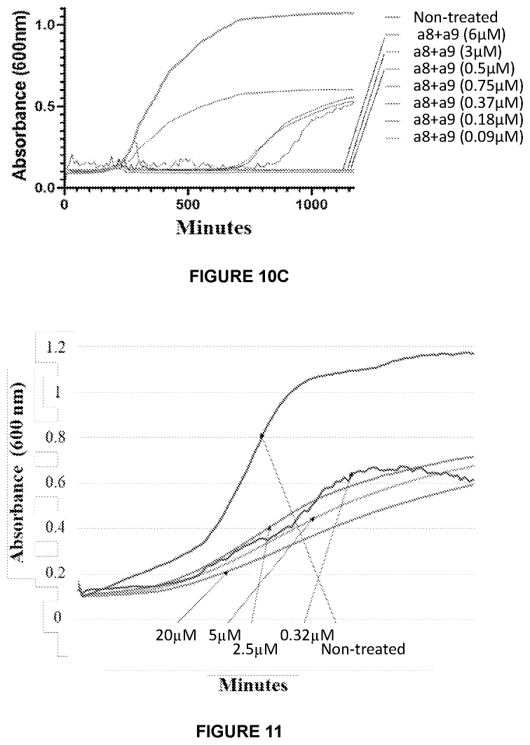

E. coli cells in LB media were incubated in a 96-well plate at 37° C. with S100a8 (FIG. 10A) or S100a9 (FIG. 10B) at concentrations varying from 0.18 μM to 50 μM. Optical density was measured every 10 minutes by absorbance at 600 nm over the course of approximately 19 hours. Full inhibition of E. coli growth was demonstrated at 1.5 μM S100a8 and below. In addition, the same experiment was performed using varying equimolar concentrations of S100a8 and S100a9 that were pre-incubated for two hours at 4° C. under constant shaking. Inhibition of E. coli growth was observed (FIG. 10C).

### Example 11. S100a12 Inhibits Growth of Candida albicans

C. albicans cells in RPMI-MOPS were incubated in a 96-well plate at 30° C. with S100a12 at concentrations of 0.32, 2.5, 5 and 20 μM (FIG. 11). Optical density was measured every 10 minutes by absorbance at 600 nm over the course of approximately 19 hours. Significant inhibition of C. albicans growth was demonstrated at concentrations as low as 0.32 μM of S100a12.

### Example 12. Psoriasin Baked in Bread/Rolls Inhibits Mold Growth

Bread or roll dough prepared with 150 ml PBS, 0.3% psoriasin, (1.5 g protein in 150 ml DDW) or 0.3% calcium propionate (1.5 g calcium propionate in 150 ml DDW) was baked in a bread maker according to the manufacturer protocol using the following recipe: 180 ml water (or 150 ml PBS+30 ml water), 1 teaspoon of salt, 2 spoons of sugar, 2 spoons of oil, 300 g of flour, and 1 teaspoon of yeast. Following baking, the bread was sliced, each slice/roll was weighed and kept in a separate small smasher bag until analysis.

Bread/rolls were stored at room temperature. Each day, a roll/slice of bread from each group was mixed with autoclaved 1×PBS at a weight ratio of 1:10 to the weighted piece of bread in the bag. The bread was then smashed in a smasher at normal speed for 120 seconds. 10 mL from the smashed bread was removed, vortexed, and diluted with autoclaved 1×PBS as necessary. Samples were plated on both PDA and LB plates and incubated at 30° C. and 37° C., respectively. All samples were performed in duplicate.

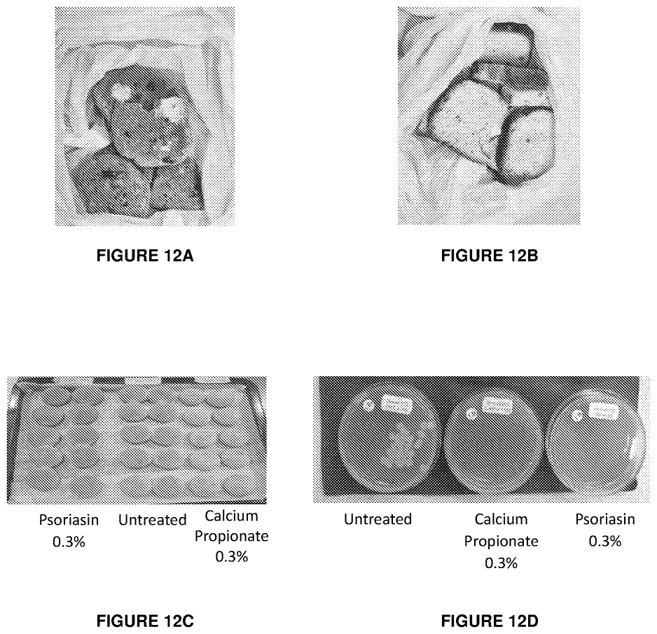

As demonstrated in FIGS. 12A-12D, no microbial growth was detected in the psoriasin-treated rolls after 10 days. In contrast, the samples in which no preservative was added showed significant microbial growth.

### Example 13. Psoriasin Increases the Shelf Life of Plant-Based Meat Substitute by 3-Fold

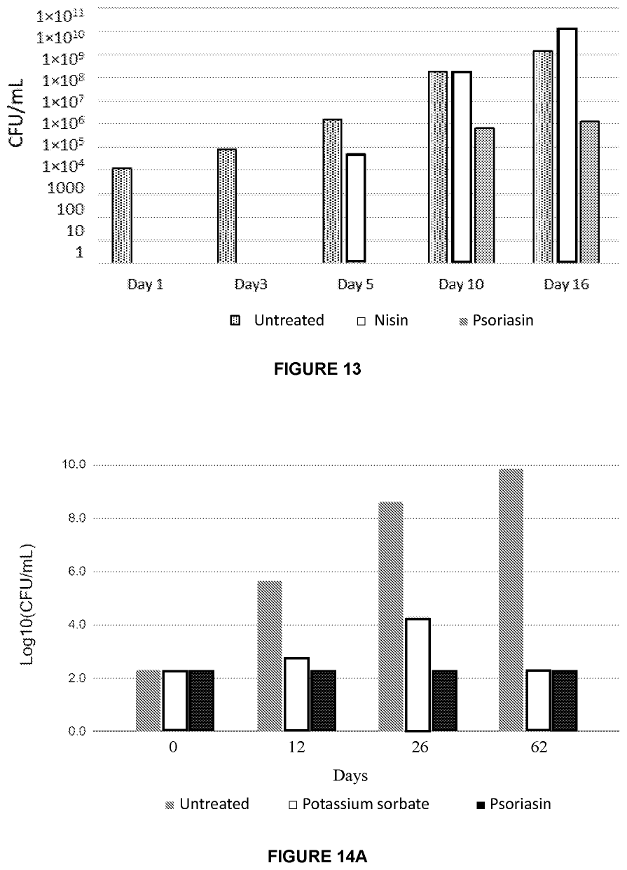

The ability of psoriasin to extend the shelf life of a plant-based meat substitute was examined under standard storage conditions. Three groups, each stored as an open package at V° C., were assessed over the course of 16 days. The groups included i) an untreated control, ii) a nisin-treated sample, and iii) a psoriasin-treated sample at 0.65%. A single source of the plant-based meat substitute was used and each group was reproduced in triplicate. The microbial load of the plant-based meat substitute samples was based on the initial microbial load without the addition of antibiotics and without the addition of mold, yeast or bacteria. Samples from each group were taken on days 1, 3, 5, 10, 11 and 16 and total CFU count was determined by plating on LB and PDA agar petri dishes. Table 1 and FIG. 13 show that the psoriasin group had 4 logs (10,000×) less microbial load than the other two groups.

TABLE 1
Microbial load
Total CFU count

| Time Point (days) | Non-Treated | Nisin | Psoriasin |
|---|---|---|---|
| Day 1 | 1.2 × 10⁴ | 1.2 × 10⁴ | 1.2 × 10⁴ |
| Day 3 | 8 × 10⁴ | 1.2 × 10⁴ | 1.2 × 10⁴ |
| Day 5 | 1.56 × 10⁶ | 5 × 10⁴ | 1.2 × 10⁴ |
| Day 10 | 1.82 × 10⁸ | 1.8 × 10⁸ | 6.65 × 10⁵ |
| Day 11 | 1.36 × 10⁹ | 2.35 × 10⁸ | 6.5 × 10⁵ |
| Day 16 | 3.3 × 10⁸ | 1.28 × 10¹⁰ | 2.4 × 10⁶ |

Yeast & Mold Count

| | | Commercial | |
|---|---|---|---|
| | | Preservative | |
| Time Point (days) | Non-Treated | (NisinZ) | Psoriasin |
| Day 1 | 2 × 10² | 2 × 10² | 2 × 10² |
| Day 3 | 4 × 10² | 2 × 10² | 2 × 10² |
| Day 5 | 7.41 × 10⁴ | 1.4 × 10³ | 2 × 10² |
| Day 10 | 7.41 × 10⁴ | 1.47 × 10⁴ | 2 × 10² |
| Day 11 | 7.33 × 10⁵ | 1.46 × 10⁴ | 2 × 10² |
| Day 16 | 3.9 × 10⁴ | 3.2 × 10⁴ | 1 × 10³ |

### Example 14. Psoriasin Extends the Shelf Life of Hummus Salad at pH 6.5 and pH 4.8 Compared with Nisin and Potassium Sorbate

The ability of psoriasin to extend the shelf life of a hummus salad preparation was examined. A commercially-available preparation that is acidified at pH 4.8 and to which 0.2% potassium sorbate was added in order to ensure food safety was compared to a hummus salad at the same pH with and without the addition of psoriasin at the same concentration. No antibiotics were added and there was no addition of mold, yeast or bacteria to the preparation.

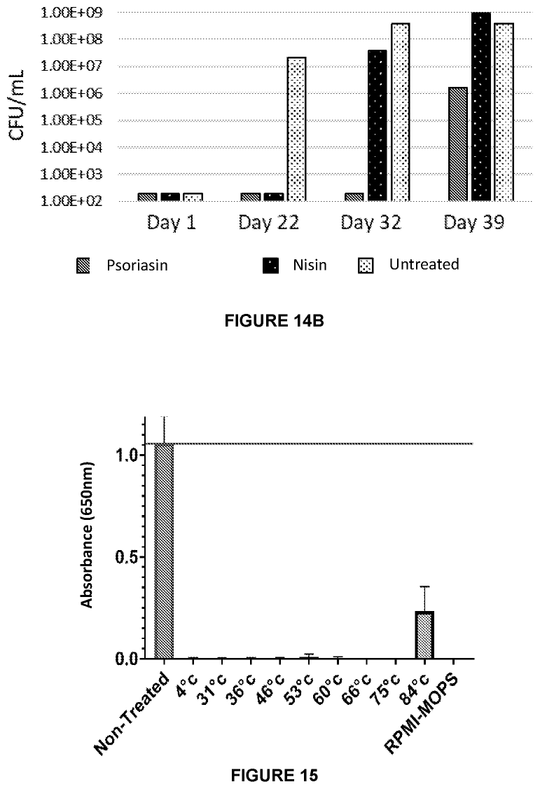

Samples were stored at 6° C. and total CFU counts were performed on days 0, 12, 26, and 62 by plating on LB and PDA agar petri dishes. Photos (i.e., visual inspection) were taken every 7 days. As is evident from FIG. 14A, psoriasin extended the shelf life of the hummus salad at pH 4.8 by 2 months.

In a further related example, the ability of psoriasin to extend the shelf life of a canned hummus spread preparation was compared with that of nisin, a commonly used preservative at pH 6.5, the natural pH of the preparation. As described above, no antibiotics were added and there was no addition of mold, yeast or bacteria to the hummus spread. The hummus spread was split into 3 groups: i) untreated, ii) nisin-treated, and iii) psoriasin-treated. The hummus spread was stored at 6° C. in an open container. Total CFU count was determined by plating on LB and PDA agar petri dishes. Remarkably, no microbial growth in the psoriasin-treated group was observed for over 32 days. This sample showed unexpected and superior antimicrobial activity in comparison to the nisin-treated group (FIG. 14B).

### Example 15. Thermal Stability of Psoriasin

In order to assess its thermal stability, psoriasin stock (36 mg/mL in 1×PBS) was subjected to various temperatures ranging from 4° C. to 84° C. for one hour. The thermally treated psoriasin was subsequently used in a microbial growth inhibition test based on standardized protocols M27 (yeasts) and M38 (filamentous fungi) of the Clinical and Laboratory Standards Institute. As is shown in FIG. 15, psoriasin maintained its inhibitory properties following exposure to all tested temperatures.

In another study, psoriasin stock (36 mg/mL in 1×PBS) was exposed to temperatures of 70° C., 80° C., and 90° C. for periods of 15, 30, and 60 minutes. After thermal exposure, the activity of the protein was assessed against E. coli in a standard growth assay with 0.4%, 0.2% or 0.1% psoriasin. Psoriasin maintained its ability to inhibit the growth of E. coli at all concentrations following exposure to all temperatures for 15 minutes. In addition, psoriasin exposed to 70° C. at all time points retained full antimicrobial activity against E. coli at all concentrations, and psoriasin exposed to 80° C. and 90° C. for 1 hour also inhibited the growth of E. coli, though to a lesser extent.

### Example 16. IC₉₀ of Psoriasin in Fungal and Bacterial Microorganisms

The IC₉₀ of psoriasin for several microorganisms was determined by Microbial Growth Inhibition Tests. The tests were performed using the Broth Microdilution Optical Method based on standardized protocols M27 (yeasts) and M38 (filamentous fungi) of the Clinical and Laboratory Standards Institute. RPMI-1614 MOPS, LB (Luria-Bertani), and TSB (Terrific Soy Broth) medium types were used, depending on the species being tested. The absorbance was calibrated to each species, and was measured between 450 nm to 650 nm.

As shown in Table 2, bacterial growth was inhibited at concentrations of 50-100 μM psoriasin. Furthermore, growth of A. flavus, a fungus, and of C. albicans, a yeast, were inhibited at concentrations of psoriasin in the nanomolar range.

TABLE 2
IC₉₀ values of psoriasin for various microorganisms

| Species | Type | Medium | IC₉₀ | |
|---|---|---|---|---|
| Aspergillus flavus | Fungi | RPMI-MOPS | 0.6 | μM |
| Escherichia coli | Bacteria | LB, TSB | 100 | μM |
| Candida albicans | Yeast | RPMI-MOPS | 0.5 | μM |
| Listeria monocytogenes | Bacteria | LB, TSB | 75 | μM |
| Lactobacillus saeki | Bacteria | TSB | 50 | μM |
| Lactococcus lactis | Bacteria | TSB | 45 | μM |
| Enterobacter cloacae | Bacteria | TSB | 28 | μM |

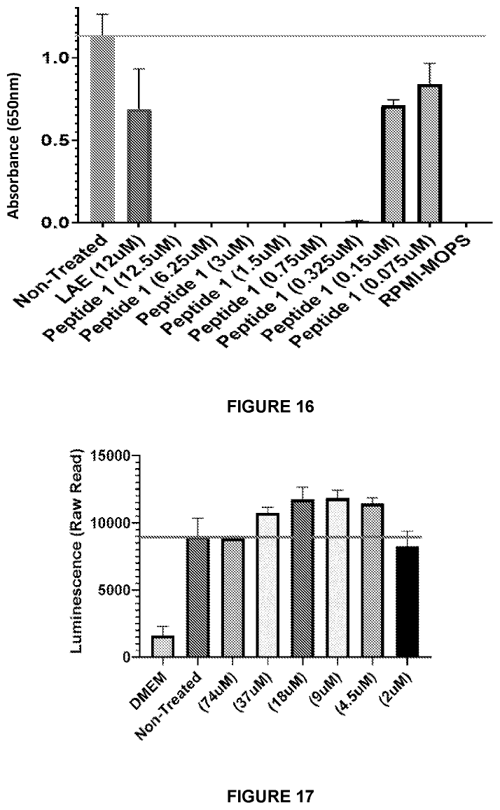

In addition, ethyl lauroyl arginate (LAE), a commercially available food preservative, was tested in similar growth conditions as a reference. In particular, the inhibition of A. flavus growth was assessed at different concentrations of psoriasin and at 12 μM LAE. As demonstrated in FIG. 16, while psoriasin inhibited 100% of detectable growth at concentrations of 0.6 μM and above as well as nearly all growth at concentrations of 0.325 μM and above, 12 μM LAE only inhibited growth by approximately 40%.

### Example 17. Psoriasin is not Harmful to Cells

To assess any potential deleterious effects of psoriasin, such as cytotoxicity, a cell viability assay was performed based on luminescence, in which decreased luminescence is indicative of reduced cell viability. Various concentrations of psoriasin ranging from 2-74 μM, were tested on 3T3 cells. Approximately 5000 cells were plated in each well of a 96 well-plate and following overnight incubation, psoriasin was added in the indicated concentration within the medium to the cells (performed in triplicate). Luminescence values were recorded after an additional 24 h using the cell-titer kit (Promega Ltd.) in a BioTek Synergy plate reader. No change in luminescence was detected at all tested concentrations of psoriasin (FIG. 17).

### Example 18. Drying Psoriasin after Purification does not Affect its Antimicrobial Properties

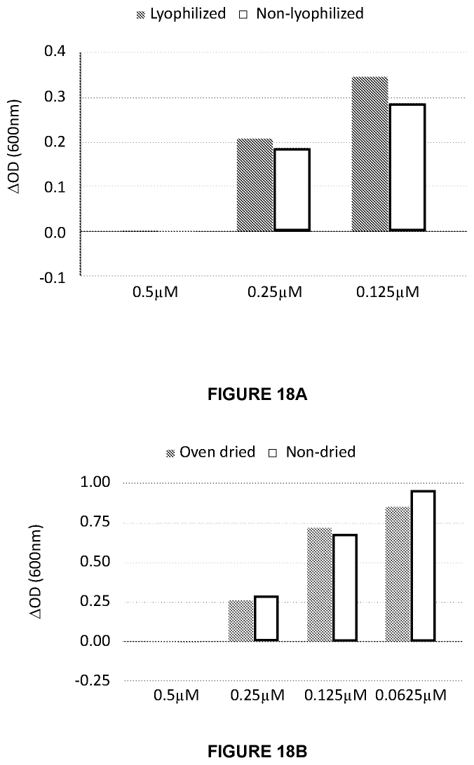

The activity of psoriasin was assessed following lyophilization and oven drying. The anti-fungal activity against C. albicans was then assessed and compared with psoriasin that did not undergo drying or lyophilization. In particular, psoriasin was lyophilized and then tested for antimicrobial activity against C. albicans at concentrations of 0.5, 0.25, and 0.125 μM compared with psoriasin that had not been lyophilized. At all concentrations, the lyophilized protein showed the same activity as that of psoriasin that was not lyophilized (FIG. 18A).

In another experiment, psoriasin was oven-dried at 50° C. for 24 hours. Subsequently, psoriasin was tested for antimicrobial activity against C. albicans at concentrations of 0.5, 0.25, 0.125, 0.0625 μM compared with psoriasin that was not dried. The oven dried psoriasin showed the same activity against C. albicans as that of psoriasin which had not been oven dried (FIG. 18B).

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

1.-32. (canceled)

33. A method for inhibiting microbial proliferation and/or microbial-induced spoilage in a food or beverage, the method comprising adding a composition comprising at least one S100 protein to the food or beverage.

34. The method of claim 33, wherein the at least one S100 protein is selected from the group consisting of S100a3, S100a7, S100a8, S100a9, S100a12, S100a15, S100b, and homologs thereof.

35. The method of claim 34, wherein the at least one S100 protein is S100a7 or a homolog thereof.

36. The method of claim 35, wherein the at least one S100 protein is S100a7 having an amino acid sequence as set forth in SEQ ID NO: 1; or wherein the at least one S100 protein comprises an amino acid sequence having at least 80% homology to the sequence as set forth in SEQ ID NO: 1.

37. The method of claim 33, wherein the microbial proliferation and/or microbial-induced spoilage is induced by fungi.

38. The method of claim 37, wherein the fungi comprise yeast or mold.

39. The method of claim 38, wherein the yeast comprises at least one of Zygosaccharomyces rouxii, Saccharomyces cerevisiae, Pichia membranaefaciens, Candida crusei, Dekkera bruxellensis, Pichia anomala, Zygosaccharomyces baiii, Dekkera naardensis, and Candida albicans; or wherein the mold comprises at least one of Aspergillus flavus, Byssochlamys nivea, Byssochlamys fulva, Neosartorya fischeri, Talaromyces harzanium, Fusarium solani, Aspergillus fumigatis, Aspergillus niger, Penicillium crustosum, Penicillium digitatum, Penicillium roqueforti, Fusarium oxysporum, and Mucor rouxii.

40. The method of claim 33, wherein the microbial proliferation and/or microbial-induced spoilage is induced by bacteria.

41. The method of claim 40, wherein the bacteria comprise at least one of Brochothrix thermosphacta, Carnobacterium spp., Lactobacillus spp., Lactococcus spp., Leuconostoc spp., Pediococcus spp., Stretococcus spp., Kurthia zopfii, Clostridium perfringens, Escherichia coli, Salmonella spp., Listeria monocytogenes, Enterobacter spp., and Weissella spp.

42. The method claim 33, wherein the concentration of the at least one S100 protein in the food or beverage which is effective in inhibiting microbial proliferation and/or microbial-induced spoilage is at least 50 nM; or wherein the concentration of the at least one S100 protein in the food or beverage is in the range of about 100 nM to about 500 μM.

43. The method of claim 33, wherein the food or beverage has a pH in the range of about 1 to about 12; or wherein the food or beverage has a pH in the range of about 5 to about 10.

44. The method of claim 33, wherein the food or beverage comprise divalent ions and wherein the molar ratio between the divalent ions concentration and the at least one S100 protein in the food or beverage is about 1:1 or less; or wherein the food comprises a water content of at least 5%; or wherein the food is semi-solid or solid; or wherein the food is selected from the group consisting of meat or poultry products, substitute meat or poultry products, fish products, fish substitute products, dairy products, substitute dairy products, bakery products, fruit and vegetable dishes, confectionaries, snack foods, soups, sauces, spreads, and dressings; or wherein the beverage is selected from the group consisting of soft drinks, juices and nectars, milk and milk-based drinks, substitute milk and milk-based drinks, hot drinks, and alcoholic drinks.

45. The method of claim 33, wherein the composition is in the form of a solution, a paste, a gel or a powder; or wherein the composition further comprises at least one additive selected from the group consisting of antioxidants, flavoring agents, nutrients, sweeteners, thickeners, colorants, emulsifiers, antifoaming agents, and a mixture or combination thereof; or wherein the at least one S100 protein is provided in combination with at least one additional food or beverage preservative selected from the group consisting of nisin, potassium sorbate, sodium benzoate, sodium nitrate, sodium nitrite, benzoic acid, and a mixture or combination thereof.

46. The method of claim 33, which extends the shelf life of the food or beverage by at least 1.5 to 10-fold compared to the shelf life of the food or beverage without any added preservatives.

47. A food or a beverage comprising an effective amount of a composition comprising at least one S100 protein as a preservative.

48. The food or beverage of claim 47, wherein the at least one S100 protein is selected from the group consisting of S100a3, S100a7, S100a8, S100a9, S100a12, S100a15, S100b, and homologs thereof.

49. The food or beverage of claim 48, wherein the at least one S100 protein is S100a7 or a homolog thereof.

50. The food or beverage of claim 49, wherein the at least one S100 protein is S100a7 having an amino acid sequence as set forth in SEQ ID NO: 1; or wherein the at least one S100 protein comprises an amino acid sequence having at least 80% homology to the sequence as set forth in SEQ ID NO: 1.

51. The food or beverage of claim 47, wherein the food is selected from the group consisting of meat or poultry products, substitute meat or poultry products, fish products, fish substitute products, dairy products, substitute dairy products, bakery products, fruit and vegetable dishes, confectionaries, snack foods, soups, sauces, spreads, and dressings; or wherein the beverage is selected from the group consisting of soft drinks, juices and nectars, milk and milk-based drinks, substitute milk and milk-based drinks, hot drinks, and alcoholic drinks.

52. The food or beverage of claim 47, which is essentially devoid of additional food or beverage preservatives.
